(19) United States
(12) Patent Application Publication
(10) Pub. No.: US 2025/0344096 A1
(43) Pub. Date: Nov. 6, 2025

(54) WIRELESS SENSING METHOD AND APPARATUS

(71) Applicant: HUAWEI TECHNOLOGIES CO., LTD., Shenzhen (CN)

(72) Inventors: Gerile NAREN, Shenzhen (CN); Mengshi HU, Shenzhen (CN); Rui DU, Singapore (SG); Xiao HAN, Shenzhen (CN); Yunbo LI, Shenzhen (CN)

(21) Appl. No.: 19/272,028

(22) Filed: Jul. 17, 2025

Related U.S. Application Data
(63) Continuation of application No. PCT/CN2024/072914, filed on Jan. 18, 2024.

(30) Foreign Application Priority Data
Jan. 18, 2023 (CN) 202310090938.6

(51) Int. Cl. H04W 24/10; H04L 5/00; H04W 8/22; H04W 84/12

(52) U.S. Cl. CPC H04W 24/10; H04L 5/0053; H04W 8/22; H04W 84/12

(57) ABSTRACT

Embodiments of this application relate to a wireless sensing method and an apparatus, and are applied to a sensing system, for example, an 802.11bf protocol or a next-generation sensing protocol of the 802.11bf protocol. The method includes: An AP sends a sensing measurement setup termination frame, to terminate a sensing MS but retain a sensing session. The sensing measurement setup termination frame includes indication information, to notify a U-STA to send a sensing measurement setup query frame before first time. The AP receives the sensing measurement setup query frame. According to this method, the AP can initiate a new sensing measurement setup with the U-STA in a condition of retaining the sensing session, to facilitate subsequent sensing measurement. This application is further applied to a UWB-based WPAN system or the like, and may be further applied to a WLAN system of an 802.11 series protocol.

### CROSS-REFERENCE TO RELATED APPLICATIONS

This application is a continuation of International Application No. PCT/CN2024/072914, filed on Jan. 18, 2024, which claims priority to Chinese Patent Application No. 202310090938.6, filed on Jan. 18, 2023. The disclosure of the aforementioned applications are hereby incorporated by reference in their entireties.

### TECHNICAL FIELD

This application relates to the field of wireless communication technologies, and in particular, to a wireless sensing method and an apparatus.

### BACKGROUND

Due to wide deployment of wireless fidelity (wireless fidelity, Wi-Fi) devices and an increase in sensing (Sensing) requirements, sensing performed by widely available Wi-Fi devices is a hot topic of current research. In daily life, a signal sent by a Wi-Fi device is usually received only after being reflected, diffracted, and scattered by various obstacles. Due to this phenomenon, an actually received signal is usually a superposition of a plurality of signals. Therefore, a wireless signal may sense a physical environment through which the wireless signal passes, and a surrounding environment may be inferred by analyzing the wireless signal “modulated” by various obstacles, to derive a wireless local area network (wireless local area network, WLAN) sensing (sensing) technology (which may also be briefly referred to as a wireless sensing technology). WLAN sensing is a technology with a broad application prospect. In the WLAN sensing technology, widely deployed Wi-Fi devices may be used to send specific data or communication channel probe frames to sense a surrounding environment, receive signal echoes or feedback information generated by peer devices in a wireless network, and then extract corresponding parameters in the received signals according to specific algorithms for analysis, to obtain surrounding environment information.

An 802.11bf standard is a standard formulated by the Institute of Electrical and Electronics Engineers (institute of electrical and electronics engineers, IEEE) for wireless sensing (WLAN sensing). The standard specifies a protocol for sensing on a sub-7 GHz frequency band and a 60 GHz frequency band. As defined in the protocol, a general sensing procedure (sensing procedure) mainly includes five phases: sensing session setup, sensing measurement setup, sensing measurement instance, sensing measurement setup termination, and sensing session termination. For specific implementation of each phase, refer to the 802.11bf protocol. Details are not described herein.

Sensing measurement is performed in the sensing measurement instance. Sensing measurement is usually performed between one access point (access point, AP) and one or more non-access point stations (non-AP stations, non-AP STAs). A non-AP STA participating in sensing may be associated (associated) with the AP, or may not be associated (unassociated) with the AP. For ease of description, a non-AP STA that is not associated (unassociated) with the AP is briefly referred to as an unassociated station (unassociated non-AP STA, U-STA) in this specification. However, in the conventional technology, no sensing measurement termination mechanism is provided between the AP and the U-STA.

### SUMMARY

Embodiments of this application provide a wireless sensing method and an apparatus, so that an AP can initiate a new sensing measurement setup with a U-STA in a condition of retaining a sensing session and terminating a sensing measurement setup, to facilitate subsequent sensing measurement.

The following describes this application from different aspects. It should be understood that, for the following implementations and beneficial effect of the different aspects, refer to each other.

According to a first aspect, this application provides a wireless sensing method. The method includes: An AP sends a first sensing measurement setup termination (sensing measurement setup termination) frame to a U-STA, to terminate a sensing measurement setup but retain a sensing session. The first sensing measurement setup termination frame includes first indication information, the first indication information is used to notify (or indicates) the U-STA to send a sensing measurement setup query frame before first time. The AP may receive, before the first time, the sensing measurement setup query frame sent by the U-STA. It may be understood that the sensing measurement setup query frame sent by the U-STA is used to notify the AP of a capability and presence of the U-STA, to perform WLAN sensing.

In this application, the AP sends the sensing measurement setup termination frame, to terminate the sensing measurement setup but retain the sensing session, and the first indication information is carried in the sensing measurement setup termination frame, to notify the U-STA to come back to send the sensing measurement setup query frame to the AP before the first time, so that the AP can initiate a new sensing measurement setup with the U-STA in a condition of retaining the sensing session and terminating the sensing measurement setup, to facilitate subsequent sensing measurement, and further make a sensing procedure between the AP and the U-STA more flexible.

With reference to the first aspect, in a possible implementation, the first sensing measurement setup termination frame is used to terminate all sensing measurement setups between the AP and the U-STA, or the first sensing measurement setup termination frame is used to terminate all trigger-based TB sensing measurement setups between the AP and the U-STA.

With reference to the first aspect, in a possible implementation, after the AP receives the sensing measurement setup query frame sent by the U-STA, the method further includes: The AP sends a sensing measurement setup request frame to the U-STA, to request to set up a new sensing measurement setup with the U-STA. Then the AP receives a sensing measurement setup response frame returned by the U-STA, where the sensing measurement setup response frame indicates that the U-STA accepts or rejects the request of the AP.

With reference to the first aspect, in a possible implementation, the first indication information includes latest time at which the U-STA sends the sensing measurement setup query frame, and optionally, further includes earliest time at which the U-STA sends the sensing measurement setup query frame. The first time is the latest time. In other words, the U-STA needs to send the sensing measurement setup query frame before the latest time. After the AP sends the first sensing measurement setup termination frame to the U-STA, the method further includes: The AP starts an unassociated station comeback timer T3 based on the first indication information. A value of the unassociated station comeback timer T3 is determined based on time indicated by the first indication information. For details, refer to descriptions in the following method embodiments. Details are not described herein.

In an implementation, the AP starts the unassociated station comeback timer T3 based on the first indication information when receiving an acknowledgment frame sent by the U-STA for the first sensing measurement setup termination frame.

In this application, the latest time at which the U-STA sends the sensing measurement setup query frame is provided based on the first indication information, to determine the value of the unassociated station comeback timer T3, and facilitate starting the unassociated station comeback timer T3.

In an implementation, the first sensing measurement setup termination frame further includes second indication information, to indicate whether the first indication information exists. In this application, the second indication information is set to a first value (for example, 1), to indicate that the first indication information exists, that is, the first indication information exists in the first sensing measurement setup termination frame. For example, the second indication information is in a measurement setup termination control field in the first sensing measurement setup termination frame.

In this application, the second indication information indicates whether the first indication information exists in the sensing measurement setup termination frame. Therefore, a design is flexible, and compatibility is strong.

With reference to the first aspect, in a possible implementation, the first indication information is a comeback (comeback) field, and the comeback field indicates whether the U-STA needs to send the sensing measurement setup query frame. In this application, the comeback field is set to a first value (for example, 1), to notify (or indicate) the U-STA to send the sensing measurement setup query frame before the first time. The first time is time in which an unassociated station activity timer counts down to zero. In other words, the U-STA needs to send the sensing measurement setup query frame before T2 counts down to zero. In other words, the U-STA needs to send the sensing measurement setup query frame in an active period of the sensing session, or the U-STA needs to send the sensing measurement setup query frame before the sensing session ends (or is terminated). That is, the first time is time at which the sensing session ends (or is terminated).

In this application, one bit indicates whether the U-STA needs to send the sensing measurement setup query frame. This implies that the first time is the time in which the unassociated station activity timer T2 counts down to zero. Therefore, signaling overheads are low, and a frame format of the sensing measurement setup termination frame is slightly changed.

With reference to the first aspect, in a possible implementation, after the AP sends the first sensing measurement setup termination frame to the U-STA, the method further includes: The AP resets the unassociated station activity timer T2 to a preset value. For example, the preset value is 100 s (seconds). For example, the AP resets the unassociated station activity timer T2 to the preset value when receiving the acknowledgment frame sent by the U-STA for the sensing measurement setup termination frame.

The sensing session is terminated when the unassociated station activity timer T2 expires. Therefore, to retain the sensing session, in this application, the unassociated station activity timer T2 and the unassociated station comeback timer T3 are properly set to retain the sensing session. This ensures that T2 does not end before T3 ends, and further prevents a sensing session from being repeatedly set up after the sensing session is terminated due to T2 expiration (T2 expired), thereby reducing overheads.

With reference to the first aspect, in a possible implementation, after the AP receives the sensing measurement setup query frame sent by the U-STA, the method further includes: The AP sends a second sensing measurement setup termination frame, where the second sensing measurement setup termination frame is used to terminate the sensing session. The AP sets the unassociated station activity timer to a second value. For example, the second value is zero.

According to a second aspect, this application provides a wireless sensing method. The method includes: A U-STA receives a first sensing measurement setup termination frame sent by an AP, where the first sensing measurement setup termination frame is used to terminate a sensing measurement setup but retain a sensing session, the first sensing measurement setup termination frame includes first indication information, and the first indication information is used to notify (or indicates) the U-STA to send a sensing measurement setup query frame before first time. The U-STA sends the sensing measurement setup query frame to the AP based on the first indication information, to notify the AP of a capability and presence of the U-STA, to perform WLAN sensing. For example, the U-STA sends the sensing measurement setup query frame to the AP before the first time (certainly, outside a sensing measurement time window).

With reference to the second aspect, in a possible implementation, the first sensing measurement setup termination frame is used to terminate all sensing measurement setups between the AP and the U-STA, or the first sensing measurement setup termination frame is used to terminate all trigger-based TB sensing measurement setups between the AP and the U-STA.

With reference to the second aspect, in a possible implementation, after the U-STA sends the sensing measurement setup query frame to the AP, the method further includes: The U-STA receives a sensing measurement setup request frame sent by the AP, where the sensing measurement setup request frame is used to request to set up a new sensing measurement setup with the U-STA. The U-STA returns a sensing measurement setup response frame to the AP, to indicate that the U-STA accepts or rejects the request of the AP.

With reference to the second aspect, in a possible implementation, the first indication information includes latest time at which the U-STA sends the sensing measurement setup query frame, and optionally, further includes earliest time at which the U-STA sends the sensing measurement setup query frame. The first time is the latest time. In other words, the U-STA needs to send the sensing measurement setup query frame before the latest time. After the U-STA receives the first sensing measurement setup termination frame sent by the AP, the method further includes: The U-STA starts an unassociated station comeback timer T3 based on the first indication information. A value of the unassociated station comeback timer T3 is determined based on time indicated by the first indication information. For details, refer to descriptions in the following method embodiments. Details are not described herein.

In an implementation, the U-STA starts the unassociated station comeback timer T3 based on the first indication information after sending an acknowledgment frame for the first sensing measurement setup termination frame. This facilitates aligning of an unassociated station comeback timer T3 of the AP and the unassociated station comeback timer T3 of the U-STA.

In this application, the U-STA maintains T2 and T3 of the U-STA, and the AP maintains T2 and T3 of the AP. In other words, the U-STA has T2 and T3 of the U-STA, and the AP also has T2 and T3 of the AP. In addition, T2 of the U-STA is consistent with T2 of the AP, and T3 of the U-STA is also consistent with T3 of the AP.

In an implementation, the first sensing measurement setup termination frame further includes second indication information, to indicate whether the first indication information exists. In this application, the second indication information is set to a first value (for example, 1), to indicate that the first indication information exists, that is, the first indication information exists in the first sensing measurement setup termination frame. For example, the second indication information is in a measurement setup termination control field in the first sensing measurement setup termination frame.

With reference to the second aspect, in a possible implementation, the first indication information is a comeback (comeback) field, and the comeback field indicates whether the U-STA needs to send the sensing measurement setup query frame. In this application, the comeback field is set to a first value (for example, 1), to notify (or indicate) the U-STA to send the sensing measurement setup query frame before the first time. Before the U-STA sends the sensing measurement setup query frame to the AP, the method further includes: The U-STA determines that the first time is time in which the unassociated station activity timer T2 counts down to zero. In other words, the U-STA needs to send the sensing measurement setup query frame before T2 counts down to zero. In other words, the U-STA needs to send the sensing measurement setup query frame in an active period of the sensing session, or the U-STA needs to send the sensing measurement setup query frame before the sensing session ends (or is terminated).

With reference to the second aspect, in a possible implementation, after the U-STA receives the first sensing measurement setup termination frame sent by the AP, the method further includes: The U-STA resets the unassociated station activity timer T2 to a preset value. For example, the preset value is 100 s (seconds). For example, the U-STA resets the unassociated station activity timer T2 to the preset value after sending the acknowledgment frame for the sensing measurement setup termination frame.

With reference to the second aspect, in a possible implementation, after the U-STA sends the sensing measurement setup query frame to the AP, the method further includes: The U-STA receives a second sensing measurement setup termination frame sent by the AP, where the second sensing measurement setup termination frame is used to terminate the sensing session. The U-STA sets the unassociated station activity timer T2 to a second value. For example, the second value is zero.

According to a third aspect, this application provides a communication apparatus, configured to perform the method in any one of the first aspect or the possible implementations of the first aspect. The communication apparatus includes a unit for performing the method in any one of the first aspect or the possible implementations of the first aspect.

For example, the communication apparatus may be an AP or a chip, and the chip may be applied to the AP.

According to a fourth aspect, this application provides a communication apparatus, configured to perform the method in any one of the second aspect or the possible implementations of the second aspect. The communication apparatus includes a unit for performing the method in any one of the second aspect or the possible implementations of the second aspect.

For example, the communication apparatus may be a U-STA or a chip, and the chip may be applied to the U-STA.

In the third aspect or the fourth aspect, the communication apparatus may include a transceiver unit and a processing unit. For specific descriptions of the transceiver unit and the processing unit, refer to apparatus embodiments provided below. For beneficial effect of the third aspect and the fourth aspect, refer to the related descriptions of the first aspect and the second aspect. Details are not described herein again.

According to a fifth aspect, this application provides a wireless sensing method. The method includes: A U-STA sends a first sensing measurement setup termination frame to an AP, where the first sensing measurement setup termination frame is used to terminate a sensing measurement setup but retain a sensing session. The U-STA resets an unassociated station activity timer T2 to a preset value. For example, the preset value is 100 s. For example, the U-STA resets the unassociated station activity timer T2 to the preset value when receiving an acknowledgment frame from the AP for the first sensing measurement setup termination frame.

In this application, a terminate U-STA sensing session field in the sensing measurement setup termination frame is set to 0. This indicates that the sensing session is retained.

In this application, the U-STA sends the sensing measurement setup termination frame to terminate the sensing measurement setup but retain the sensing session, and resets the unassociated station activity timer T2 to the preset value. This can prolong a life cycle of the sensing session between the U-STA and the AP, and prevent a sensing session from being repeatedly set up when there is a sensing requirement, thereby reducing overheads; and can further improve setting of the timer in a sensing measurement setup termination phase, thereby avoiding setting confusion.

With reference to the fifth aspect, in a possible implementation, before the U-STA resets the unassociated station activity timer T2 to the preset value, the method further includes: The U-STA determines that an unassociated station comeback timer T3 is running. This can ensure that T2 does not end before T3 ends, and further prevent a sensing session from being repeatedly set up after the sensing session is terminated due to T2 expiration (T2 expired), thereby reducing overheads.

With reference to the fifth aspect, in a possible implementation, the first sensing measurement setup termination frame is used to terminate all sensing measurement setups between the AP and the U-STA.

With reference to the fifth aspect, in a possible implementation, after the U-STA resets the unassociated station activity timer T2 to the preset value, the method further includes: The U-STA sends a second sensing measurement setup termination frame, where the second sensing measurement setup termination frame is used to terminate the sensing session. The U-STA sets both the unassociated station activity timer T2 and the unassociated station comeback timer T3 to a second value. For example, the second value is zero.

According to a sixth aspect, this application provides a wireless sensing method. The method includes: An AP receives a first sensing measurement setup termination frame sent by a U-STA, where the first sensing measurement setup termination frame is used to terminate a sensing measurement setup but retain a sensing session. The AP resets an unassociated station activity timer T2 to a preset value. For example, the preset value is 100 s. For example, the AP resets the unassociated station activity timer T2 to the preset value after sending an acknowledgment frame for the first sensing measurement setup termination frame.

In this application, a terminate U-STA sensing session field in the sensing measurement setup termination frame is set to 0. This indicates that the sensing session is retained.

With reference to the sixth aspect, in a possible implementation, before the AP resets the unassociated station activity timer T2 to the preset value, the method further includes: The AP determines that an unassociated station comeback timer T3 is running.

With reference to the sixth aspect, in a possible implementation, the first sensing measurement setup termination frame is used to terminate all sensing measurement setups between the AP and the U-STA.

With reference to the sixth aspect, in a possible implementation, after the AP resets the unassociated station activity timer T2 to the preset value, the method further includes: The AP receives a second sensing measurement setup termination frame, where the second sensing measurement setup termination frame is used to terminate the sensing session. The AP sets both the unassociated station activity timer T2 and the unassociated station comeback timer T3 to a second value. For example, the second value is zero.

According to a seventh aspect, this application provides a communication apparatus, configured to perform the method in any one of the fifth aspect or the possible implementations of the fifth aspect. The communication apparatus includes a unit for performing the method in any one of the fifth aspect or the possible implementations of the fifth aspect.

For example, the communication apparatus may be a U-STA or a chip, and the chip may be applied to the U-STA.

According to an eighth aspect, this application provides a communication apparatus, configured to perform the method in any one of the sixth aspect or the possible implementations of the sixth aspect. The communication apparatus includes a unit for performing the method in any one of the sixth aspect or the possible implementations of the sixth aspect.

For example, the communication apparatus may be an AP or a chip, and the chip may be applied to the AP.

In the seventh aspect or the eighth aspect, the communication apparatus may include a transceiver unit and a processing unit. For specific descriptions of the transceiver unit and the processing unit, refer to apparatus embodiments provided below. For beneficial effect of the seventh aspect and the eighth aspect, refer to the related descriptions of the fifth aspect and the sixth aspect. Details are not described herein.

According to a ninth aspect, this application provides a wireless sensing method. The method includes: An AP sends a sensing measurement setup termination frame to a U-STA, where the sensing measurement setup termination frame is used to terminate a sensing session. The AP sets an unassociated station activity timer T2 to a second value. For example, the second value is zero.

In this application, the AP sends the sensing measurement setup termination frame to terminate the sensing session, and sets T2 to zero. Therefore, setting of the timer may be specified, so that setting of the timer is consistent with a meaning of the timer, to avoid setting confusion.

With reference to the ninth aspect, in a possible implementation, the AP sets the unassociated station activity timer T2 to the second value when receiving an acknowledgment frame for the sensing measurement setup termination frame.

According to a tenth aspect, this application provides a wireless sensing method. The method includes: A U-STA receives a sensing measurement setup termination frame sent by an AP, where the sensing measurement setup termination frame is used to terminate a sensing session. The U-STA sets an unassociated station activity timer T2 to a second value. For example, the second value is zero.

With reference to the tenth aspect, in a possible implementation, the U-STA sets the unassociated station activity timer T2 to the second value after sending an acknowledgment frame for the sensing measurement setup termination frame. This facilitates aligning of an unassociated station activity timer T2 of the AP and the unassociated station activity timer T2 of the U-STA.

According to an eleventh aspect, this application provides a communication apparatus, configured to perform the method in any one of the ninth aspect or the possible implementations of the ninth aspect. The communication apparatus includes a unit for performing the method in any one of the ninth aspect or the possible implementations of the ninth aspect.

For example, the communication apparatus may be an AP or a chip, and the chip may be applied to the AP.

According to a twelfth aspect, this application provides a communication apparatus, configured to perform the method in any one of the tenth aspect or the possible implementations of the tenth aspect. The communication apparatus includes a unit for performing the method in any one of the tenth aspect or the possible implementations of the tenth aspect.

For example, the communication apparatus may be a U-STA or a chip, and the chip may be applied to the U-STA.

In the eleventh aspect or the twelfth aspect, the communication apparatus may include a transceiver unit and a processing unit. For specific descriptions of the transceiver unit and the processing unit, refer to apparatus embodiments provided below. For beneficial effect of the eleventh aspect and the twelfth aspect, refer to the related descriptions of the ninth aspect and the tenth aspect. Details are not described herein.

According to a thirteenth aspect, this application provides a wireless sensing method. The method includes: A U-STA sends a sensing measurement setup termination frame to an AP, where the sensing measurement setup termination frame is used to terminate a sensing session. The U-STA sets both an unassociated station activity timer T2 and an unassociated station comeback timer T3 to a second value. For example, the second value is zero.

In this application, the U-STA sends the sensing measurement setup termination frame to terminate the sensing session, and sets both the unassociated station activity timer T2 and the unassociated station comeback timer T3 to zero. Therefore, setting of the timer may be specified, so that setting of the timer is consistent with a meaning of the timer, to avoid setting confusion.

With reference to the thirteenth aspect, in a possible implementation, the U-STA sets both the unassociated station activity timer T2 and the unassociated station comeback timer T3 to the second value when receiving an acknowledgment frame returned for a sensing measurement setup query frame.

According to a fourteenth aspect, this application provides a wireless sensing method. The method includes: An AP receives a sensing measurement setup termination frame sent by a U-STA, where the sensing measurement setup termination frame is used to terminate a sensing session. The AP sets both an unassociated station activity timer T2 and an unassociated station comeback timer T3 to a second value. For example, the second value is zero.

With reference to the fourteenth aspect, in a possible implementation, the U-STA sets both an unassociated station activity timer T2 and an unassociated station comeback timer T3 to the second value after sending an acknowledgment frame returned for a sensing measurement setup query frame. This facilitates aligning of the unassociated station activity timer T2 of the AP and the unassociated station activity timer T2 of the U-STA and aligning of the unassociated station comeback timer T3 of the AP and the unassociated station comeback timer T3 of the U-STA.

According to a fifteenth aspect, this application provides a communication apparatus, configured to perform the method in any one of the thirteenth aspect or the possible implementations of the thirteenth aspect. The communication apparatus includes a unit for performing the method in any one of the thirteenth aspect or the possible implementations of the thirteenth aspect.

For example, the communication apparatus may be a U-STA or a chip, and the chip may be applied to the U-STA.

According to a sixteenth aspect, this application provides a communication apparatus, configured to perform the method in any one of the fourteenth aspect or the possible implementations of the fourteenth aspect. The communication apparatus includes a unit for performing the method in any one of the fourteenth aspect or the possible implementations of the fourteenth aspect.

For example, the communication apparatus may be an AP or a chip, and the chip may be applied to the AP.

In the fifteenth aspect or the sixteenth aspect, the communication apparatus may include a transceiver unit and a processing unit. For specific descriptions of the transceiver unit and the processing unit, refer to apparatus embodiments provided below. For beneficial effect of the fifteenth aspect and the sixteenth aspect, refer to the related descriptions of the thirteenth aspect and the fourteenth aspect. Details are not described herein.

According to a seventeenth aspect, this application provides a communication apparatus. The communication apparatus may include a processor, a transceiver, and a memory. The memory is configured to store a computer program. The transceiver is configured to send and receive various messages. The computer program includes program instructions. When the processor runs the program instructions, the communication apparatus is enabled to perform the method described in any one of the first aspect, the second aspect, the fifth aspect, the sixth aspect, the ninth aspect, the tenth aspect, the thirteenth aspect, the fourteenth aspect, or the possible implementations of the aspects. The transceiver may be a radio frequency module, a combination of a radio frequency module and an antenna, or an input/output interface of a chip or a circuit in the communication apparatus.

According to an eighteenth aspect, this application provides a communication apparatus. The communication apparatus includes a logic circuit and an interface, and the logic circuit is coupled to the interface. The logic circuit and the interface are configured to perform the method in any one of the first aspect, the second aspect, the fifth aspect, the sixth aspect, the ninth aspect, the tenth aspect, the thirteenth aspect, the fourteenth aspect, or the possible implementations of the aspects.

According to a nineteenth aspect, this application provides a computer-readable storage medium. The computer-readable storage medium is configured to store a computer program. When the computer program is run on a computer, the method in any one of the first aspect, the second aspect, the fifth aspect, the sixth aspect, the ninth aspect, the tenth aspect, the thirteenth aspect, the fourteenth aspect, or the possible implementations of the aspects is performed.

According to a twentieth aspect, an embodiment of this application provides a computer program product. The computer program product includes a computer program or computer code. When the computer program product runs on a computer, the method in any one of the first aspect, the second aspect, the fifth aspect, the sixth aspect, the ninth aspect, the tenth aspect, the thirteenth aspect, the fourteenth aspect, or the possible implementations of the aspects is performed.

According to a twenty-first aspect, this application provides a computer program. When the computer program is run on a computer, the method in any one of the first aspect, the second aspect, the fifth aspect, the sixth aspect, the ninth aspect, the tenth aspect, the thirteenth aspect, the fourteenth aspect, or the possible implementations of the aspects is performed.

According to a twenty-second aspect, this application provides a wireless communication system. The wireless communication system includes an AP and a U-STA. The AP is configured to perform the method in any one of the first aspect, the sixth aspect, the ninth aspect, the fourteenth aspect, or the possible implementations of the aspects; and the U-STA is configured to perform the method in any one of the second aspect, the fifth aspect, the tenth aspect, the thirteenth aspect, or the possible implementations of the aspects.

For technical effect achieved in the foregoing aspects, refer to each other or technical effect in method embodiments described below. Details are not described herein.

### BRIEF DESCRIPTION OF DRAWINGS

FIG. 1 is a diagram of a sensing procedure between a U-STA and an AP according to an embodiment of this application;

FIG. 2 is a diagram of a sensing state change of a U-STA according to an embodiment of this application;

FIG. 3 is a diagram of a frame format of a sensing measurement setup termination frame according to an embodiment of this application;

FIG. 4 is a diagram of a frame format of a measurement setup termination control field according to an embodiment of this application;

FIG. 5 is a diagram of an architecture of a communication system according to an embodiment of this application;

FIG. 6a is a diagram of a structure of an access point according to an embodiment of this application;

FIG. 6b is a diagram of a structure of a station according to an embodiment of this application;

FIG. 7 is a schematic flowchart of a wireless sensing method according to an embodiment of this application;

FIG. 8a is a diagram of another frame format of a sensing measurement setup termination frame according to an embodiment of this application;

FIG. 8b is a diagram of another frame format of a measurement setup termination control field according to an embodiment of this application;

FIG. 9 is a diagram of still another frame format of a sensing measurement setup termination frame according to an embodiment of this application;

FIG. 10 is another schematic flowchart of a wireless sensing method according to an embodiment of this application;

FIG. 11 is still another schematic flowchart of a wireless sensing method according to an embodiment of this application;

FIG. 12 is yet another schematic flowchart of a wireless sensing method according to an embodiment of this application;

FIG. 13 is a diagram of a structure of a communication apparatus according to an embodiment of this application;

FIG. 14 is a diagram of another structure of a communication apparatus according to an embodiment of this application; and

FIG. 15 is a diagram of still another structure of a communication apparatus according to an embodiment of this application.

### DESCRIPTION OF EMBODIMENTS

The following clearly describes technical solutions in embodiments of this application with reference to accompanying drawings in embodiments of this application.

In descriptions of this application, “first”, “second”, and the like are merely intended to distinguish between different objects but do not indicate a particular order. In addition, unless otherwise specified, “/” represents “or”. For example, A/B may represent A or B. In this specification, “and/or” describes only an association relationship between associated objects and represents that there may be three relationships. For example, A and/or B may represent the following three cases: Only A exists, both A and B exist, and only B exists. In addition, “at least one” means one or more, and “a plurality of” means two or more. At least one of the following items (pieces) or a similar expression thereof indicates any combination of these items, including a single item (piece) or any combination of a plurality of items (pieces). For example, at least one item (piece) of a, b, or c may indicate a, b, c, a and b, a and c, b and c, or a, b, and c, where a, b, and c may be singular or plural.

In addition, the terms “include”, “have”, and any variants thereof are intended to cover a non-exclusive inclusion. For example, processes, methods, systems, products, or devices that include a series of steps or units are not limited to listed steps or units, but instead, optionally further include steps or units that are not listed, or optionally further include other steps or units inherent to these processes, methods, products, or devices.

In this application, the word “example” or “for example” is used to represent giving an example, an illustration, or a description. Any embodiment or design scheme described as “example”, “such as” or “for example” in this application should not be explained as being more preferred or having more advantages than another embodiment or design scheme. Exactly, use of the word “example”, “such as”, “for example”, or the like is intended to present a related concept in a specific manner.

It should be understood that, in this application, “when”, “if”, and “provided that” all mean that an apparatus performs corresponding processing in an objective situation, and are not intended to limit time. The terms do not mean that the apparatus is needed to perform a determining action during implementation, and do not mean any other limitation.

In this application, unless otherwise specified, an element indicated in a singular form is intended to indicate “one or more”, but does not indicate “one and only one”.

It may be understood that in embodiments of this application, “B corresponding to A” indicates that there is a correspondence between A and B, and B may be determined based on A. Determining B based on A does not mean that B is determined based only on A, and B may alternatively be determined based on A and/or other information.

The following briefly describes some related content, terms, or nouns in this application.

### 1. Roles and Definitions in WLAN Sensing

Sensing initiator (sensing initiator): is a station that initiates a sensing procedure by sending a wireless sensing measurement setup request frame (sensing initiator: A station (STA) that initiates a WLAN sensing procedure by transmitting the WLAN Sensing Measurement Setup Request frame.).

Sensing responder (sensing responder): is a station that participates in a wireless sensing procedure by responding to a sensing initiator (sensing responder: A station (STA) that participates in a WLAN sensing procedure by responding to a sensing initiator.).

Sensing transmitter (sensing transmitter): is a station that sends a PPDU for sensing measurement in a sensing procedure (sensing transmitter: A station (STA) that transmits PPDUs used for measurements in a WLAN sensing procedure.).

Sensing receiver (sensing receiver): is a station that receives a physical layer (physical layer, PHY) protocol data unit (PHY protocol data unit, PPDU) sent by a sensing transmitter and obtains a measurement result in a wireless sensing procedure (sensing receiver: A station (STA) that receives PPDUs sent by a sensing transmitter and obtains measurements in a WLAN sensing procedure.).

Wireless local area network sensing (wireless local area network (WLAN) sensing): Measurement values are obtained by using physical layer (physical layer, PHY) and medium access control (medium access control, MAC) features of a station, and these measurement values may help estimate features of an object in a region of interest, for example, a distance, a velocity, and motion (The use of physical layer (PHY) and medium access control (MAC) features of stations (STAs) to obtain measurements that may be useful to estimate features such as range, velocity, and motion of objects in an area of interest.).

Wireless local area network sensing procedure (wireless local area network (WLAN) sensing procedure): is a process in which a station is allowed to perform WLAN sensing (A procedure that allows a station (STA) to perform WLAN sensing.).

### 2. General Sensing Procedure

An 802.11bf protocol specifies a protocol for sensing on a sub-7 GHz frequency band and a 60 GHz frequency band. As defined in the 802.11bf protocol, a general sensing procedure may include the following five phases:

(1) Sensing session setup (sensing session setup): indicates that a sensing session is set up between stations, where a sensing initiator and a sensing responder exchange sensing capability information in this phase. It should be understood that the sensing session is a protocol set up between two stations: one sensing initiator and one sensing responder. One sensing initiator may maintain sensing sessions with a plurality of sensing responders, but the plurality of sensing sessions still need to be set up one by one.

(2) Sensing measurement setup (sensing measurement setup): A sensing initiator and a sensing responder negotiate and unify measurement parameters used in a sensing procedure in this phase, for example, a role of the sensing responder, and for another example, parameters such as a measurement feedback type, where the role herein means that the sensing responder participates in a sensing measurement process as a sensing transmitter (sensing transmitter, sensing TX) or a sensing receiver (sensing receiver, sensing RX).

(3) Sensing measurement instance (sensing measurement instance): Sensing measurement is performed in the sensing measurement instance. A plurality of sensing responders are allowed to participate in one sensing measurement instance.

(4) Sensing measurement setup termination (sensing measurement setup termination): A sensing measurement setup corresponding to a sensing responder is terminated (that is, this group of measurement parameters is no longer used to perform sensing measurement), and the sensing responder is no longer bound to the corresponding sensing measurement setup, but the sensing responder may still be in a sensing session.

(5) Sensing session termination (sensing session termination): A sensing session is terminated, and sensing measurement is no longer performed.

Sensing measurement is usually performed between one AP and one or more non-AP STAs. Sensing measurement between one AP and one or more non-AP STAs may be classified into two types: trigger-based (trigger-based, TB) sensing measurement and non-trigger-based (non-trigger-based, non-TB) sensing measurement. In TB sensing measurement, an AP initiates a sensing measurement procedure as a sensing initiator, and one or more non-AP STAs participate in the sensing measurement procedure as a sensing responder. In non-TB sensing measurement, a non-AP STA initiates a sensing measurement procedure as a sensing initiator, and an AP participates in the sensing measurement procedure as a sensing responder.

A non-AP STA participating in sensing may be associated (associated) with the AP, or may not be associated (unassociated) with the AP. A non-AP STA that is not associated (unassociated) with the AP is briefly referred to as an unassociated station (unassociated non-AP STA, U-STA) in this specification.

It may be understood that the U-STA may initiate a sensing measurement procedure as a sensing initiator, that is, non-TB sensing measurement, or may participate, as a sensing responder, in a sensing procedure initiated by the AP, that is, TB sensing measurement. This application mainly focuses on sensing measurement between the AP and the U-STA.

### 3. U-STA Participating in TB Sensing

When a non-AP STA is associated with an AP, the AP may learn of capability information of the non-AP STA, including but not limited to sensing capability information, for example, a maximum bandwidth, whether feedback of a sensing measurement report is supported, and whether sensing measurement from a sensing responder to a sensing responder (sensing responder to sensing responder, SR2SR) is supported. In addition, the AP may further learn of scheduling information of the non-AP STA, for example, time at which the non-AP STA enters a power saving mode, time at which the non-AP STA is in an active state, and the like. However, when the non-AP STA is not associated with the AP, the non-AP STA is referred to as a U-STA, and the AP learns of neither capability information of the U-STA nor scheduling information of the U-STA. Therefore, if the AP wants to set up a sensing connection or a sensing session (sensing session) to the U-STA, the AP needs the U-STA to first indicate presence of the U-STA to the AP and notify the AP of capability information of the U-STA. In this way, the AP can perform a subsequent operation with the U-STA, for example, set a sensing measurement parameter, that is, perform a sensing measurement setup (sensing measurement setup) and the like.

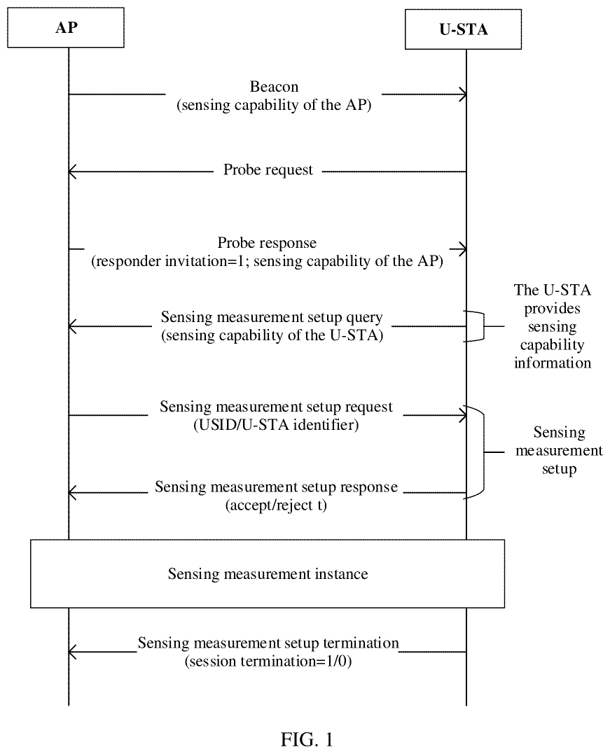

FIG. 1 is a diagram of a sensing procedure between a U-STA and an AP according to an embodiment of this application. As shown in FIG. 1, the AP periodically sends beacon (Beacon) frames in a broadcast mode. The beacon frame carries some capability information of the AP, for example, sensing capability information of the AP (AP's sensing capabilities). After the U-STA obtains the beacon frame through listening, if the U-STA is interested in the AP, the U-STA may send a probe request (probe request) frame to the AP, to request more comprehensive capability information from the AP. The AP returns a probe response (probe response) frame, to notify the U-STA of capability information of the AP, and indicate that the AP needs a sensing responder to participate in sensing measurement. Based on this, the U-STA may choose whether to be associated with the AP. If the U-STA chooses to be associated with the AP, an association (association) process may be completed based on an association request frame and an association response frame, and completion of the association process indicates sensing session setup completion. Then the AP and the associated non-AP STA may perform processes such as a sensing measurement setup and sensing measurement. Details are not described herein.

If the U-STA does not want to be associated with the AP, but is willing to participate in sensing measurement as a sensing responder, as shown in FIG. 1, the U-STA may send a sensing measurement setup query (sensing measurement setup query) frame to the AP to notify the AP of sensing capability information of the U-STA, for example, a maximum bandwidth, whether feedback of a sensing measurement report is supported, a maximum quantity of supported sensing measurement setups, and the like. If the AP considers that the U-STA meets a sensing measurement setup requirement, the AP may send a sensing measurement setup request (sensing measurement setup request) frame to request to set up a sensing measurement setup with the U-STA. In the sensing measurement setup request frame, the AP sets a sensing measurement parameter of the U-STA, for example, a time window for performing sensing measurement. The U-STA may return a sensing measurement setup response (sensing measurement setup response) frame, to indicate that the U-STA accepts or rejects the request of the AP. It may be understood that sensing measurement setup completion herein also indicates that sensing session setup completion. If the U-STA accepts the request of the AP, the U-STA and the AP may perform sensing measurement in a sensing measurement instance based on the negotiated measurement time window.

### 4. Sensing State Machine of a U-STA

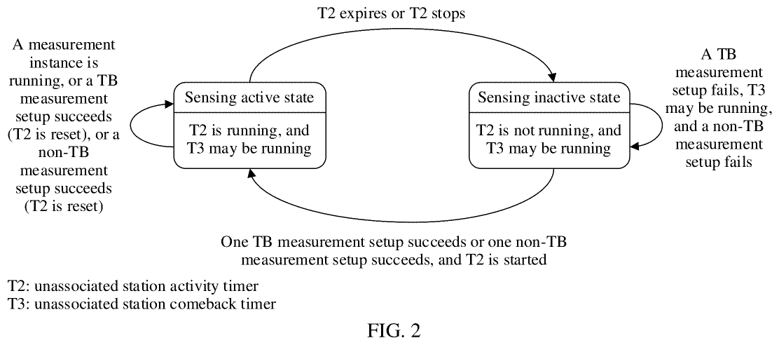

When the U-STA participates in sensing, the U-STA maintains the sensing state machine (sensing state machine). The sensing state machine has two states: an active state (Active state) and an inactive state (Inactive state). The active state may indicate that a sensing session (sensing session) exists between the U-STA and an AP, and the inactive state may indicate that no sensing session exists between the U-STA and the AP. FIG. 2 is a diagram of a sensing state change of a U-STA according to an embodiment of this application.

There are two timers in FIG. 2: an unassociated station activity timer (unassociated STA activity timer) denoted as T2, and an unassociated station comeback timer (unassociated STA comeback timer) denoted as T3. The U-STA maintains T2 and T3 of the U-STA, and the AP maintains T2 and T3 of the AP. In other words, the U-STA has T2 and T3 of the U-STA, and the AP also has T2 and T3 of the AP. In addition, T2 of the U-STA is consistent with T2 of the AP, and T3 of the U-STA is also consistent with T3 of the AP.

T2 may indicate a life cycle of a sensing session. T2 starts to operate, that is, starts to count down, when a sensing session is set up between the U-STA and the AP. When T2 is terminated, the sensing session between the U-STA and the AP is also terminated. For a U-STA, a setup of a sensing session is indicated by the U-STA and the AP successfully completing a sensing measurement setup. Therefore, T2 is started only when the U-STA and the AP successfully complete the sensing measurement setup. In an operating sensing session, T2 is reset (reset) when one sensing measurement setup is successfully completed or when sensing measurement is performed (that is, a measurement instance is running). It may be understood that each reset of T2 may indicate that a sensing activity is being performed between the U-STA and the AP.

The AP may set up a plurality of sensing measurement setups with the U-STA based on a requirement of a sensing application. One sensing measurement setup corresponds to one group of measurement parameters, and different sensing measurement setups correspond to different measurement parameters. In this case, the AP may need the U-STA to send a sensing measurement setup query frame to the AP in a future time period. In this way, the AP may send a new sensing measurement setup request frame to the U-STA to set up a new sensing measurement setup. The “future time period” may be controlled by the timer T3. To be specific, the U-STA needs to come back (comeback) to send the sensing measurement setup query frame to the AP before T3 ends. At the beginning of a sensing measurement setup, the AP notifies, based on the sensing measurement setup request frame, the U-STA to start T3. This indicates that the AP does not perform sensing measurement with the U-STA currently, but may perform sensing measurement later (in this case, T2 is not started because the AP and the U-STA fail to complete a sensing measurement setup). When performing sensing measurement, the AP may notify, in a first sent frame, for example, a sensing polling trigger frame (sensing polling trigger frame), the U-STA to come back to send a sensing measurement setup query frame at specific time after the current sensing measurement is completed (T2 is reset at the same time).

As shown in FIG. 2, the sensing state change of the U-STA may be summarized as follows:

(1) From an inactive state to an active state: A sensing session is successfully set up between the U-STA and the AP, that is, the U-STA and the AP successfully complete a sensing measurement setup, and T2 is started (start T2). Herein, the U-STA and the AP each maintain one T2.

(2) From the active state to an active state: A sensing activity is being performed between the U-STA and the AP, for example, sensing measurement is being performed (that is, a measurement instance is running), or another sensing measurement setup is successfully set up. In this case, T2 is reset (reset). T3 may be started in the sensing measurement instance (measurement instance). It may be understood that T2 starts to count down from startup. If no sensing activity is performed between the U-STA and the AP, equivalently, the U-STA is idle, T2 continues to count down. When T2 counts down to zero, the sensing session between the U-STA and the AP is terminated. Therefore, T2 may be understood as maximum duration in which the U-STA can maintain no sensing activity. After T2 counts down to zero, if the AP subsequently wants to perform sensing with the U-STA again, the AP needs to set up a sensing session with the U-STA again.

(3) From the active state to an inactive state: The sensing session is terminated. The sensing session is terminated in two manners. One is an implicit termination manner, for example, T2 counts down to zero, that is, T2 expires (T2 expires). The other is an explicit termination manner, for example, the U-STA or the AP sends a sensing measurement setup termination (sensing measurement setup termination) frame to terminate the sensing session.

(4) From the inactive state to the inactive state: The sensing measurement setup between the U-STA and AP fails. A possible cause of the failure is as follows: The AP does not need the U-STA for sensing measurement, and T3 may be started at this time; or the AP and the U-STA do not negotiate measurement parameters.

### 5. Sensing Measurement Setup Termination

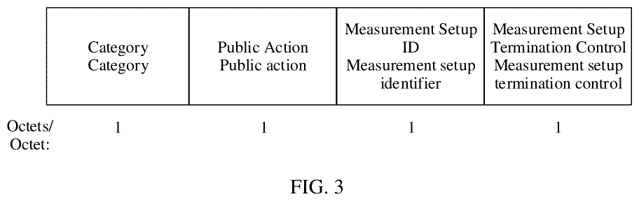

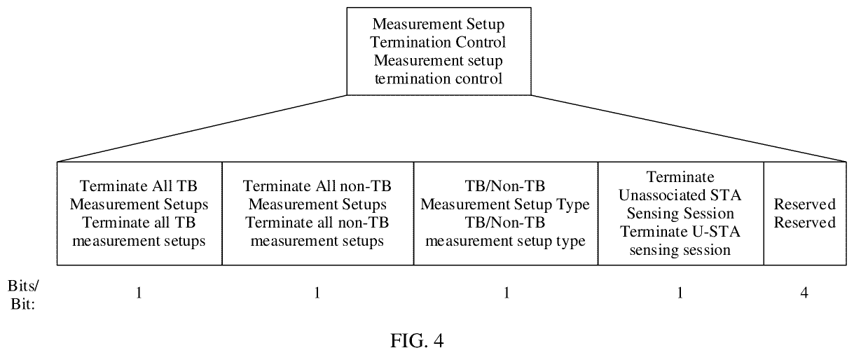

An AP or a non-AP STA (which may be associated with the AP or may not be associated with the AP) may send a sensing measurement setup termination frame to terminate some or all sensing measurement setups (sensing measurement setups), and may also be used to terminate a sensing session. In a protocol, a frame format of the sensing measurement setup termination frame is shown in FIG. 3. FIG. 3 is a diagram of a frame format of the sensing measurement setup termination frame according to an embodiment of this application. In FIG. 3, the sensing measurement setup termination frame includes but is not limited to a category (category) field, a public action (Public Action) field, a measurement setup identifier (measurement setup ID, MSID) field, and a measurement setup termination control (measurement setup termination control) field. A frame format of the measurement setup termination control field is shown in FIG. 4. The measurement setup termination control field includes but is not limited to a terminate all TB measurement setups (terminate all TB measurement setups) field, a terminate all non-TB measurement setups (terminate all non-TB measurement setups) field, a TB/non-TB measurement setup type (TB/Non-TB measurement setup type) field, a terminate U-STA sensing session (terminate unassociated STA sensing session) field, a reserved bit, and the like. When the terminate all TB measurement setups field is set to 1, it indicates that all TB sensing measurement setups between the AP and the non-AP STA are terminated. When the terminate all TB measurement setups field is set to 0, it indicates reservation. When the terminate all non-TB measurement setups field is set to 1, it indicates that all non-TB sensing measurement setups between the AP and the non-AP STA are terminated. When the terminate all non-TB measurement setups field is set to 0, it indicates reservation. When the terminate U-STA sensing session field is set to 1, it indicates that a sensing session is terminated. When the terminate U-STA sensing session field is set to 0, it indicates that a sensing session is retained.

In an implementation, one sensing measurement setup may be represented by one MSID, and one MSID may be used to identify one sensing application. Sensing measurement setup termination may achieve two purposes. One is to release resources. Each sensing measurement setup requires resources to store information and a measurement result. The other is to release an MSID. In a protocol, the MSID is not allowed to be repeatedly used unless a previous sensing measurement setup corresponding to the MSID is terminated. For example, if a same application initiates a new sensing requirement, a same MSID but different measurement parameters may be used. In this case, the sensing measurement setup needs to be terminated, and then a new sensing measurement setup is to be set up.

The following briefly describes a system architecture in this application.

The technical solutions provided in this application are applicable to a WLAN sensing system. For example, a method provided in this application is applicable to the 802.11bf protocol, a future-generation WLAN sensing protocol, or the like. The method provided in this application is also applicable to other 802.11 protocols, for example, the 802.11a/b/g protocol, the 802.11n protocol, the 802.11ac protocol, the 802.11ax protocol, the 802.11be protocol, Wi-Fi 7, or a next-generation protocol like Wi-Fi 8. Examples are not enumerated one by one herein.

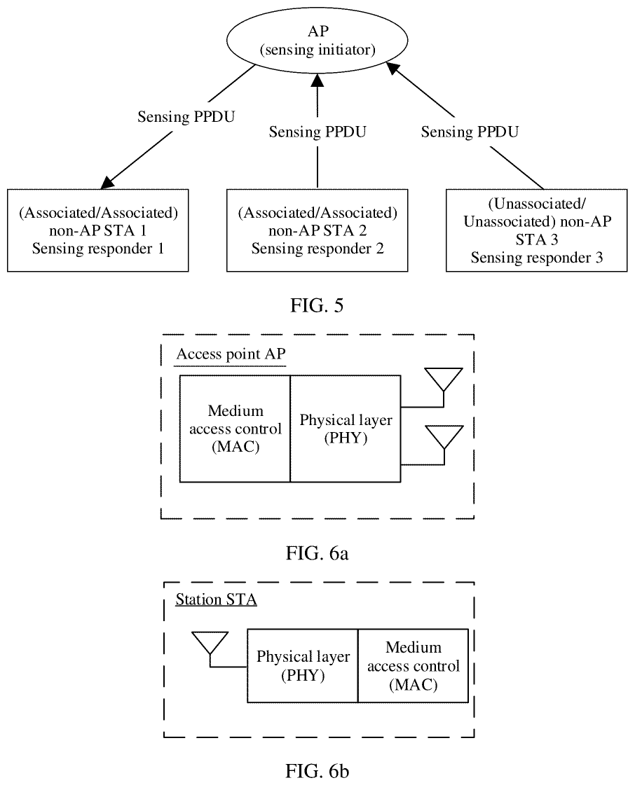

FIG. 5 is a diagram of an architecture of a communication system according to an embodiment of this application. As shown in FIG. 5, the communication system includes one or more APs and one or more non-AP STAs (for example, a non-AP STA 1, a non-AP STA 2, and a non-AP STA 3 in FIG. 5). The AP initiates a sensing measurement procedure as a sensing initiator, and the one or more non-AP STAs participate in the sensing measurement procedure as a sensing responder. The non-AP STA may be associated or unassociated with the AP. For example, in FIG. 1, the non-AP STA 1 and the non-AP STA 2 are separately associated with the AP, and the non-AP STA 3 (namely, a U-STA) is not associated with the AP. In an implementation, the AP may maintain an unassociated station activity timer (T2) and an unassociated station comeback timer (T3), and the non-AP STA 3 (namely, the U-STA) may also maintain an unassociated station activity timer (T2) and an unassociated station comeback timer (T3).

In an implementation, both the non-AP STA and the AP support a WLAN communication protocol, for example, the 802.11bf protocol. Certainly, with continuous evolution and development of communication technologies, the communication protocol may further include a next-generation protocol of 802.11bf, and the like.

In this specification, the non-access point station (non-AP STA) may also be briefly referred to as a station (station, STA), and the two may be used interchangeably.

The access point (for example, the AP in FIG. 5) is an apparatus having a wireless communication function, supports communication according to a WLAN protocol, has a function of communicating with another device (for example, a station or another access point) in a WLAN network. It is clear that the access point may further have a function of communicating with another device. In a WLAN system, the access point may be referred to as an access point station (access point station, AP STA). The apparatus having the wireless communication function may be an entire device, or may be a chip, a processing system, or the like installed in the entire device. The device in which the chip or processing system is installed may implement methods and functions in embodiments of this application under control of the chip or processing system. The AP in embodiments of this application is an apparatus that provides a service for a STA, and may support the 802.11 series protocols. For example, the AP may be a communication entity, for example, a communication server, a router, a switch, or a bridge. The AP may include a macro base station, a micro base station, a relay station, and the like in various forms. Certainly, the AP may alternatively be a chip or a processing system in these devices in various forms, to implement the methods and the functions in embodiments of this application.

The station (for example, any non-AP STA in FIG. 5) is an apparatus having a wireless communication function, supports communication according to the WLAN protocol, and has a capability of communicating with or sensing another station or the access point in the WLAN network. In the WLAN system, the station may be referred to as a non-access point station (non-access point station, non-AP STA). For example, the STA is any user communication device that allows a user to communicate with an AP and further communicate with the WLAN. The apparatus having the wireless communication function may be an entire device, or may be a chip, a processing system, or the like installed in the entire device. The device in which the chip or processing system is installed may implement methods and functions in embodiments of this application under control of the chip or processing system. For example, the STA may be user equipment that can be connected to the internet, for example, a tablet computer, a desktop computer, a laptop computer, a notebook computer, an ultra-mobile personal computer (Ultra-mobile personal computer, UMPC), a handheld computer, a netbook computer, a personal digital assistant (personal digital assistant, PDA), or a mobile phone. Alternatively, the STA may be an internet of things node in an internet of things, an in-vehicle communication apparatus in an internet of vehicles, an entertainment device, a game device or system, a global positioning system device, or the like. Alternatively, the STA may be a chip and a processing system in the foregoing terminals.

The WLAN system can provide high-rate and low-latency transmission. With continuous evolution of WLAN application scenarios, the WLAN system is to be applied to more scenarios or industries, for example, the internet of things industry, the internet of vehicles industry, the banking industry, enterprise offices, exhibition halls of stadiums, concert halls, hotel rooms, dormitories, hospital wards, classrooms, supermarkets, squares, streets, production workshops and warehousing. Certainly, a device (for example, an access point or a station) that supports WLAN communication may be a sensor node (for example, a smart water meter, a smart electricity meter, or a smart air detection node) in a smart city, a smart device (for example, a smart camera, a projector, a display, a television, a stereo, a refrigerator, or a washing machine) in a smart home, a node in the internet of things, an entertainment terminal (for example, a wearable device like augmented reality (augmented reality, AR) or virtual reality (virtual reality, VR)), a smart device in smart office (for example, a printer, a projector, a loudspeaker, or a stereo), an internet of vehicle device in the internet of vehicle, an infrastructure (for example, a vending machine, a self-service navigation station of a supermarket, a self-service cash register device, or a self-service ordering machine) in daily life scenarios, a device in a large sports and music venue, or the like. Specific forms of the station and the access point are not limited in embodiments of this application, and are merely examples for description herein.

It should be understood that the 802.11 standard focuses on a physical layer (physical layer, PHY) and a medium access control (medium access control, MAC) layer. For example, FIG. 6a is a diagram of a structure of an access point according to an embodiment of this application. The AP may be multi-antenna/multi-radio-frequency, or may be single-antenna/single-radio-frequency. The antenna/radio frequency is used to send/receive a data packet (the data packet in this specification may also be referred to as a physical layer protocol data unit (PHY protocol data unit, PPDU)). In an implementation, an antenna part or a radio frequency part of the AP may be separated from a main body of the AP, that is, may be remotely disposed. In FIG. 6a, the AP may include a physical layer processing circuit and a medium access control processing circuit. The physical layer processing circuit may be configured to process a physical layer signal, and the MAC layer processing circuit may be configured to process a MAC layer signal. For another example, FIG. 6b is a diagram of a structure of a station according to an embodiment of this application. FIG. 6b is a diagram of a structure of a single-antenna/single-radio-frequency STA. In an actual scenario, the STA may also be multi-antenna/multi-radio-frequency, and may be a device with more than two antennas. The antenna/radio frequency is used to send/receive a data packet. In an implementation, an antenna part or a radio frequency part of the STA may be separated from a main body of the STA, that is, may be remotely disposed. In FIG. 6b, the STA may include a PHY processing circuit and a MAC processing circuit. The physical layer processing circuit may be configured to process a physical layer signal, and the MAC layer processing circuit may be configured to process a MAC layer signal.

In some embodiments, in the communication system shown in FIG. 5, the AP may be replaced with an access point multi-link device (AP multi-link device, AP MLD), and the non-AP STA may be replaced with a non-access point multi-link device (non-AP multi-link device, non-AP MLD). That is, the technical solutions provided in embodiments of this application may also be applied to a scenario in which a multi-link device (multi-link device, MLD) communicates with a multi-link device. The multi-link device is a wireless communication device that supports parallel transmission on a plurality of links. Compared with a device that supports only single-link transmission, the multi-link device has higher transmission efficiency and a higher throughput. The multi-link device includes one or more affiliated stations STAs (affiliated STAs). The affiliated STA is a logical station and may operate on one link. The affiliated station may be an access point (access point, AP) or a non-access point station (non-access point station, non-AP STA). A multi-link device whose affiliated station is an AP may be referred to as an AP MLD, and a multi-link device whose affiliated station is a non-AP STA may be referred to as a non-AP MLD.

In an implementation, the multi-link device (which may be a non-AP MLD or an AP MLD herein) in embodiments of this application is an apparatus having a wireless communication function. The apparatus may be an integrated device, or may be a chip, a processing system, or the like installed in the integrated device. A device in which the chip or processing system is installed may implement methods and functions in embodiments of this application under control of the chip or processing system.

The following describes in detail the technical solutions provided in this application with reference to more accompanying drawings.

In this application, unless otherwise specified, for same or similar parts of embodiments or implementations, refer to each other. In embodiments of this application and the implementations/implementation methods/implementation methods in embodiments, unless otherwise specified or a logical conflict occurs, terms and/or descriptions are consistent and may be mutually referenced between different embodiments and between the implementations/implementation methods/implementation methods in embodiments. Technical features in the different embodiments and the implementations/implementation methods/implementation methods in embodiments may be combined to form a new embodiment, implementation, implementation method, or implementation method based on an internal logical relationship thereof. The following implementations of this application are not intended to limit the protection scope of this application.

It can be learned from content of the fourth point (that is, the sensing state machine of the U-STA) and the fifth point (that is, sensing measurement setup termination) that, when the AP sends the sensing measurement setup termination frame to terminate all or only sensing measurement setups between the AP and the U-STA (but does not terminate the sensing session), there is no sensing measurement setup between the U-STA and the AP. In other words, the AP has no opportunity to notify the U-STA to come back to send the sensing measurement setup query frame to the AP before the specific time. In this case, if the AP has another sensing requirement and requires participation of the U-STA, the AP can set up a sensing session again with the U-STA only after the current sensing session expires, that is, T2 expires. However, after the sensing session expires, the AP cannot ensure that the U-STA is still in an active state, and cannot ensure that the U-STA is still within coverage of the AP. Therefore, when the AP retains the sensing session but has no sensing measurement setup with the U-STA, the AP cannot set up a new sensing measurement setup with the U-STA.

In view of this, embodiments of this application provide a wireless sensing method. Indication information is carried in the sensing measurement setup termination frame, to notify the U-STA to come back to send the sensing measurement setup query frame to the AP before the specific time, so that the AP can initiate a new sensing measurement setup with the U-STA in a condition of retaining the sensing session, to facilitate subsequent sensing measurement, and further make a sensing procedure between the AP and the U-STA more flexible.

In addition, only behavior of T2 during the sensing measurement setup (measurement setup, MS) and occurrence of the measurement instance (measurement instance), that is, resetting T2 when the U-STA and the AP successfully complete one sensing measurement setup or when the measurement instance occurs, is specified in the fourth point (that is, the sensing state machine of the U-STA). However, behavior (or changes) of T2 and T3 is incomplete in other cases. For example, in the sensing measurement setup termination phase, the U-STA and the AP may choose to terminate the sensing measurement setup but retain the sensing session, or may choose to terminate the sensing session. When the former occurs, that is, when the sensing measurement setup is terminated but the sensing session is retained, the behavior (or the changes) of T2 and T3 is not clear. When the latter occurs, that is, when the sensing session is terminated, setting of T2 and T3 is not specified.

In view of this, embodiments of this application further provide a wireless sensing method. The behavior of T2 and/or T3 in the sensing measurement setup termination phase is constrained. This can improve setting of the timer, thereby avoiding setting confusion; and can further prolong a life cycle of the sensing session between the U-STA and the AP, and prevent a sensing session from being repeatedly set up when there is a sensing requirement, thereby reducing overheads. In addition, according to the wireless sensing method provided in embodiments of this application, setting of the timer may be further determined, so that setting of the timer is consistent with a meaning of the timer, to avoid setting confusion.

In an implementation, the access point in embodiments of this application may be the AP shown in FIG. 5, and the unassociated station (U-STA) in embodiments of this application may be the non-AP STA 3 shown in FIG. 5. Both the access point and the unassociated station in embodiments of this application may support a WLAN sensing protocol, for example, 802.11bf or a next-generation protocol of 802.11bf.

### Embodiment 1

The embodiment 1 of this application mainly describes how an AP sets up a new sensing measurement setup with a U-STA after the AP sends a sensing measurement setup termination frame to terminate all or some sensing measurement setups between the AP and the U-STA but retain a sensing session, to perform subsequent sensing measurement.

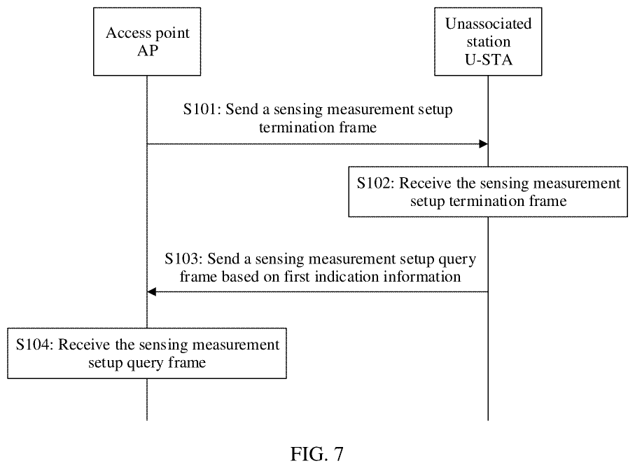

FIG. 7 is a schematic flowchart of a wireless sensing method according to an embodiment of this application. As shown in FIG. 7, the wireless sensing method includes but is not limited to the following steps.

S101: The access point (AP) sends the sensing measurement setup termination frame to the unassociated station (U-STA). The sensing measurement setup termination frame is used to terminate a sensing measurement setup but retain a sensing session, the sensing measurement setup termination frame includes first indication information, and the first indication information is used to notify the unassociated station to send a sensing measurement setup query frame before first time.

It may be understood that, because the U-STA is not associated with the AP, the AP does not know when the U-STA enters a power saving mode, and does not know whether the U-STA moves out of coverage of the AP. After the U-STA enters the power saving mode, the U-STA does not receive a sensing-related frame, for example, the sensing measurement setup termination frame. When the U-STA moves out of the coverage of the AP, the U-STA receives no frame sent by the AP. Therefore, in a sensing procedure, except for a sensing measurement instance phase (because the AP and the U-STA negotiate a sensing measurement time window in a sensing measurement setup phase, the U-STA is definitely present in the sensing measurement time window, that is, the U-STA does not enter the power saving mode, and does not move out of the coverage of the AP), before the AP wants to send information to the U-STA, the U-STA needs to first send the sensing measurement setup query frame to the AP, to indicate that the U-STA is still present.

Therefore, the AP can send the sensing measurement setup termination frame to the U-STA only after receiving the sensing measurement setup query frame sent by the U-STA. The U-STA may send the sensing measurement setup query frame to the AP at any time that is before the sensing session is terminated and that is outside the sensing measurement instance. In other words, when the AP sends the sensing measurement setup termination frame, an unassociated station comeback timer T3 is not operating (T3 is not running).

In an implementation, the AP sends the sensing measurement setup termination frame to the U-STA, to terminate all or some sensing measurement setups between the AP and the U-STA but retain the sensing session. As shown in FIG. 4, when the terminate U-STA sensing session (terminate unassociated STA sensing session) field in the sensing measurement setup termination frame is set to 0, it indicates that the sensing session is retained.

In a possible implementation, the sensing measurement setup termination frame is used to terminate all the sensing measurement setups between the AP and the U-STA (for example, both the terminate all TB measurement setups field and the terminate all non-TB measurement setups field in FIG. 4 are set to 1), or is used to terminate all TB sensing measurement setups between the AP and the U-STA (for example, the terminate all TB measurement setups field in FIG. 4 is set to 1). For example, if only one sensing measurement setup is set up between the U-STA and the AP, the sensing measurement setup termination frame may be used to terminate the MS. Alternatively, if a plurality of sensing measurement setups are set up between the U-STA and the AP, the sensing measurement setup termination frame may be used to terminate the plurality of sensing measurement setups. For another example, if two TB sensing measurement setups and three non-TB sensing measurement setups are set up between the U-STA and the AP, the sensing measurement setup termination frame may be used to terminate the two TB sensing measurement setups.

If the AP wants to retain the U-STA as a sensing responder to participate in subsequent other sensing measurement, the AP may include the first indication information in the sensing measurement setup termination frame, to notify (or indicate) the U-STA to send the sensing measurement setup query frame before the first time. Certainly, if the AP does not want to retain the U-STA as a sensing responder to participate in subsequent other sensing measurement, the AP does not indicate, in the sensing measurement setup termination frame, the U-STA to send the sensing measurement setup query frame, or does not include the first indication information in the sensing measurement setup termination frame. In this case, an unassociated station activity timer T2 of the AP and an unassociated station activity timer T2 of the U-STA may continue (continue) to count down.

In an implementation, the first indication information may include latest time at which the U-STA sends the sensing measurement setup query frame. The first time is the latest time. In other words, the U-STA needs to send the sensing measurement setup query frame before the latest time. The AP may start the unassociated station comeback timer T3 (that is, start T3) based on the first indication information after the AP sends the sensing measurement setup termination frame to the U-STA. For example, the AP may start the unassociated station comeback timer T3 based on the first indication information when receiving an acknowledgment frame sent by the U-STA for the sensing measurement setup termination frame. A value of T3 is determined based on the time provided by the first indication information. In some scenarios, the first indication information further includes earliest time at which the U-STA sends the sensing measurement setup query frame. For example, the earliest time provided by the first indication information is 2 seconds(s) later than current time, and the latest time is 10 s later than the current time. The value of T3 may be set to 10 s. Then countdown is performed, and during counting down 8 s to 0 s, the U-STA may send the sensing measurement setup query frame. For another example, the earliest time provided by the first indication information is 2 s later than the current time, and the latest time is 10 s later than the current time. T3 may start timing from 0 s. When T3 times from 2 s to 10 s, the U-STA may send the sensing measurement setup query frame. In addition, when T3 times to 10 s, timing is stopped, and the value of T3 may be reset to 0.

In an implementation, the sensing measurement setup termination frame may further include second indication information, to indicate whether the first indication information exists. When the second indication information is set to a first value, it indicates that the first indication information exists. When the second indication information is set to a second value, it indicates that the first indication information does not exist. In this embodiment of this application, the second indication information is set to the first value. The first value is 1, and the second value is 0; or the first value is 0, and the second value is 1. This is not limited in embodiments of this application.

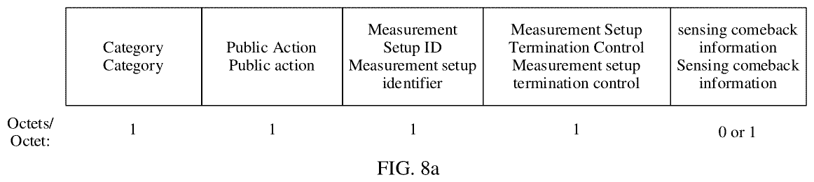

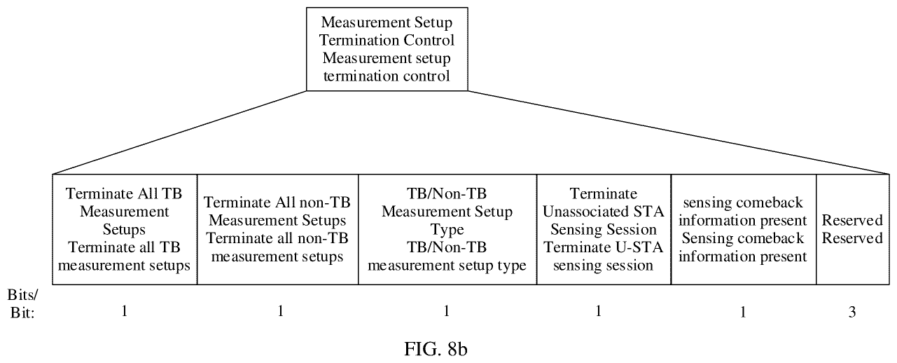

For example, the first indication information is in the sensing measurement setup termination frame. The second indication information may be in a measurement setup termination control field in the sensing measurement setup termination frame. FIG. 8a is a diagram of another frame format of the sensing measurement setup termination frame according to this embodiment of this application. FIG. 8b is a diagram of another frame format of the measurement setup termination control field according to this embodiment of this application. As shown in FIG. 8a, the sensing measurement setup termination frame includes but is not limited to a measurement setup termination control (measurement setup termination control) field, and optionally further includes a sensing comeback information (sensing comeback information) field (that is, the first indication information). The sensing comeback information field (that is, the first indication information) may provide or indicate the earliest time and the latest time at which the U-STA sends the sensing measurement setup query frame. As shown in FIG. 8b, the measurement setup termination control field includes but is not limited to a sensing comeback information present (sensing comeback information present) field (that is, the second indication information). When a value of the sensing comeback information present field (that is, the second indication information) is 1, it indicates that the sensing comeback information field (that is, the first indication information) exists in the sensing measurement setup termination frame. When a value of the sensing comeback information present field (that is, the second indication information) is 0, it indicates that the sensing comeback information field (that is, the first indication information) does not exist in the sensing measurement setup termination frame. In addition, when a value of a terminate unassociated STA sensing session field in the measurement setup termination control field is 0, it indicates that the sensing session is retained.

In an implementation, the first indication information is a comeback (comeback) field, to indicate whether the U-STA needs to send the sensing measurement setup query frame. In this embodiment of this application, the comeback field is set to the first value (for example, 1), to notify (or indicate) the U-STA to send the sensing measurement setup query frame before the first time. The first time is time in which the unassociated station activity timer T2 counts down to zero. In other words, the U-STA needs to send the sensing measurement setup query frame before T2 counts down to zero. In other words, the U-STA needs to send the sensing measurement setup query frame in an active period of the sensing session. In other words, the U-STA needs to send the sensing measurement setup query frame before the sensing session ends (or is terminated), that is, the first time is time at which the sensing session ends (or is terminated). In a further implementation, the AP may also start T3 (start T3) after the AP sends the sensing measurement setup termination frame to the U-STA, where the value of T3 may be determined based on a value of T2. For example, the value of T3 needs to be less than or equal to the current value of T2, and the AP and the U-STA need to determine values of T3 according to a same rule (a specific rule is not limited in embodiments of this application). That is, the value of T3 of the AP needs to be consistent with that of the U-STA.

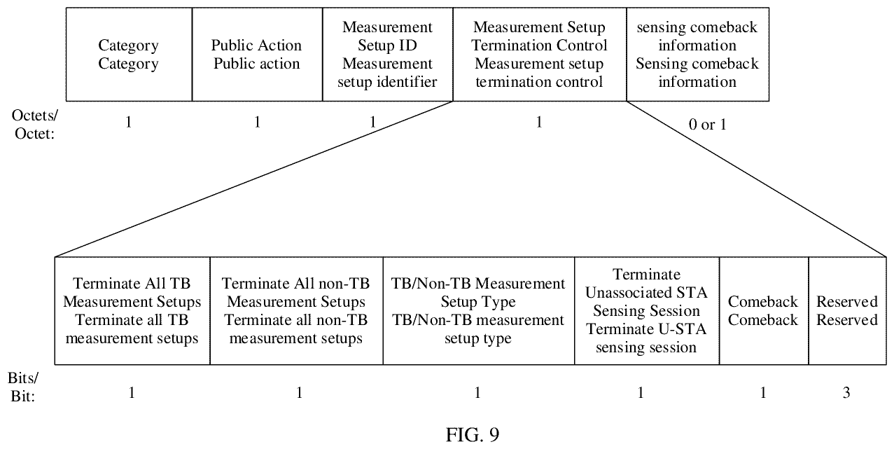

For example, the comeback field may be in the measurement setup termination control field in the sensing measurement setup termination frame. FIG. 9 is a diagram of still another frame format of the sensing measurement setup termination frame according to this embodiment of this application. As shown in FIG. 9, the sensing measurement setup termination frame includes but is not limited to a measurement setup termination control (measurement setup termination control) field. The measurement setup termination control field includes a comeback (comeback) field (that is, the first indication information). When a value of the comeback field (that is, the first indication information) is 1, it indicates that the U-STA needs to send the sensing measurement setup query frame before T2 counts down to zero. When a value of the comeback field (that is, the first indication information) is 0, it indicates that the U-STA does not need to send the sensing measurement setup query frame. In this embodiment of this application, the value of the comeback field (that is, the first indication information) is 1. In addition, when a value of a terminate unassociated STA sensing session field in the measurement setup termination control field is 0, it indicates that the sensing session is retained.

In an implementation, because T2 expires (T2 expired), the sensing session is terminated. Therefore, to prevent T2 from ending before T3, the AP may reset (reset) the unassociated station activity timer T2 to a preset value after the AP sends the sensing measurement setup termination frame to the U-STA. For example, the preset value is 100 s. For example, the AP may reset T2 to the preset value when receiving the acknowledgment frame sent by the U-STA for the sensing measurement setup termination frame. In this embodiment of this application, the sensing session can be retained by properly setting T2 and T3. This ensures that T2 does not end before T3 ends, and further prevents a sensing session from being repeatedly set up after the sensing session is terminated due to T2 expiration (T2 expired), thereby reducing overheads.

It may be understood that, if all the TB sensing measurement setups between the AP and the U-STA are terminated, only the non-TB sensing measurement setup (initiated by the U-STA) may exist between the AP and the U-STA. The AP is the sensing responder in non-TB sensing measurement, and cannot actively initiate frame exchange. Therefore, the AP cannot notify, in the non-TB sensing measurement, the U-STA to send the sensing measurement setup query frame, to set up other TB sensing measurement. Therefore, after the AP sends the sensing measurement setup termination frame, if the AP needs the U-STA to send a sensing measurement setup query frame before specific time (for example, the first time), another TB sensing activity exists between the AP and the U-STA, for the AP to have an opportunity to set T3 or have an opportunity to notify the U-STA to send the sensing measurement setup query frame, or the first indication information is carried in the sensing measurement setup termination frame, to notify the U-STA to send the sensing measurement setup query frame before the first time. In other words, when the sensing measurement setup termination frame is used to terminate all the TB sensing measurement setups between the AP and the U-STA, if the AP needs the U-STA to send the sensing measurement setup query frame, the first indication information may be carried in the sensing measurement setup termination frame. For an implementation of the first indication information, refer to the foregoing descriptions. Details are not described herein again.

In another possible implementation, the sensing measurement setup termination frame is used to terminate some sensing measurement setups between the AP and the U-STA. In other words, another sensing measurement setup exists between the AP and the U-STA. The frame format of the sensing measurement setup termination frame may be shown in FIG. 3 and FIG. 4. It may be understood that, in this implementation, T2 is reset due to a sensing activity (for example, performing sensing measurement) in the another sensing measurement setup. Therefore, after the AP sends the sensing measurement setup termination frame, T2 may continue (continue) to count down. In an implementation, to unify behavior of T2, after the AP sends the sensing measurement setup termination frame, T2 may alternatively be reset (reset) to the preset value.

It may be understood that, when the sensing measurement setup termination frame is used to terminate some sensing measurement setups between the AP and the U-STA, a TB sensing measurement setup may exist between the AP and the U-STA, in this case, the unassociated station comeback timer T3 may be started in a sensing activity of another sensing measurement setup; or only the non-TB sensing measurement setup exists between the AP and the U-STA, that is, all the TB sensing measurement setups are terminated, in this case, T3 may be started due to the first indication information carried in the sensing measurement setup termination frame.

S102: The unassociated station (U-STA) receives the sensing measurement setup termination frame. The sensing measurement setup termination frame is used to terminate all or some sensing measurement setups but retain the sensing session.

In an implementation, the sensing measurement setup termination frame is used to terminate all the sensing measurement setups between the AP and the U-STA, or is used to terminate all the TB sensing measurement setups between the AP and the U-STA. The sensing measurement setup termination frame includes the first indication information, to notify (or indicate) the U-STA to send the sensing measurement setup query frame before the first time. For specific implementation of the sensing measurement setup termination frame, refer to related descriptions in step S101. Details are not described herein again.

For example, the first indication information includes the latest time at which the U-STA sends the sensing measurement setup query frame. The U-STA may start an unassociated station comeback timer T3 (that is, start T3) based on the first indication information after receiving the sensing measurement setup query frame. For example, the U-STA starts the unassociated station comeback timer T3 based on the first indication information after sending the acknowledgment frame for the sensing measurement setup termination frame. This facilitates aligning of T3 of the AP and T3 of the U-STA. Certainly, the U-STA may also start T3 at other time. For example, the U-STA starts T3 at sending start time or sending end time of the acknowledgment frame or time of determining to send the acknowledgment frame. This is not limited in embodiments of this application. A value of T3 is determined based on the time provided by the first indication information. For details, refer to the foregoing descriptions. Details are not described herein again. The first time is the latest time. In other words, the U-STA needs to send the sensing measurement setup query frame before the latest time. In other words, the U-STA needs to send the sensing measurement setup query frame in the active period of the sensing session. In other words, the U-STA needs to send the sensing measurement setup query frame before the sensing session ends (or is terminated).

For example, the first indication information may indicate whether the U-STA needs to send the sensing measurement setup query frame. In this embodiment of this application, the first indication information is set to the first value (for example, 1), to notify (or indicate) the U-STA to send the sensing measurement setup query frame before the first time. The first time is time in which the unassociated station activity timer T2 counts down to zero. In other words, the U-STA needs to send the sensing measurement setup query frame before T2 counts down to zero. In an implementation, the U-STA may also start T3 (start T3) after receiving the sensing measurement setup termination frame, where the value of T3 may be determined based on the value of T2. For example, the value of T3 needs to be less than or equal to the current value of T2, and the AP and the U-STA need to determine values of T3 according to a same rule (a specific rule is not limited in embodiments of this application). That is, the value of T3 of the AP needs to be consistent with that of the U-STA.

In an implementation, because T2 expires (T2 expired), the sensing session is terminated. Therefore, to prevent T2 from ending before T3, the U-STA may reset (reset) T2 to the preset value after receiving the sensing measurement setup termination frame. For example, the preset value is 100 s. For example, the U-STA may reset T2 to the preset value after sending the acknowledgment frame for the sensing measurement setup termination frame. This facilitates aligning of T2 of the AP and T2 of the U-STA.

In an implementation, the sensing measurement setup termination frame is used to terminate some sensing measurement setups between the AP and the U-STA. In this case, T2 may continue (continue) to count down. In an implementation, to unify behavior of T2, after the U-STA receives the sensing measurement setup termination frame, T2 may alternatively be reset (reset) to the preset value.

In this embodiment of this application, setting of the timer in the AP and the timer in the U-STA in a sensing measurement setup termination phase is improved, to avoid setting confusion.

To more clearly understand setting of the timer in the sensing measurement setup termination phase in this embodiment of this application, behavior of T2 and T3 may be summarized in Table 1 below.

TABLE 1

| The AP sending the | T2 at U-STA and AP | T3 at U-STA and AP |
|---|---|---|
| sensing measurement | T2 of the U-STA | T3 of the U-STA |
| setup termination frame | and the AP | and the AP |
| Terminating all | The AP does not include the sensing | The AP includes the sensing |
| sensing measurement | comeback information field in the | comeback information field in |
| setups | sensing measurement setup termination | the sensing measurement |
| | frame (the value of the sensing comeback | setup termination frame (the |
| | information present field in FIG. 8b is 0), | value of the sensing comeback |
| | or the AP sets the value of the comeback | information present field in |
| | field (in FIG. 9) to 0 in the sensing | FIG. 8b is 1), and T3 is |
| | measurement setup termination frame, | started. |
| | and T2 continues. | The AP includes the |
| | The AP includes the sensing comeback | comeback field in the sensing |
| | information field in the sensing | measurement setup |
| | measurement setup termination frame | termination frame (in FIG. 9), |
| | (the value of the sensing comeback | and T3 does not change. |
| | information present field in FIG. 8b is 1), | |
| | or the AP sets the value of the comeback | |
| | field (in FIG. 9) to 1 in the sensing | |
| | measurement setup termination frame, | |
| | and T2 is reset. | |
| Terminating some | continues or is reset. | |
| sensing measurement | | |
| setups | | |

In short, the AP sends the sensing measurement setup termination frame. If the sensing measurement setup termination frame is in the frame format in FIG. 8a, when the sensing measurement setup termination frame carries the sensing comeback information field, T2 is reset and T3 is started; or when the sensing measurement setup termination frame does not carry the sensing comeback information field, T2 continues. If the sensing measurement setup termination frame is in the frame format in FIG. 9, when the value of the comeback field in the sensing measurement setup termination frame is 1, T2 is reset; or when the value of the comeback field in the sensing measurement setup termination frame is 0, T2 continues.

S103: The unassociated station (U-STA) sends the sensing measurement setup query frame to the access point (AP) based on the first indication information.

S104: The access point (AP) receives the sensing measurement setup query frame.

In an implementation, the U-STA sends the sensing measurement setup query frame to the AP before the first time (certainly, outside the sensing measurement time window), to notify the AP of a capability and presence of the U-STA to perform WLAN sensing. (The Sensing Measurement Setup Query frame is transmitted by an unassociated non-AP STA to inform its capabilities and presence to the AP to perform WLAN sensing.)

Correspondingly, the AP receives the sensing measurement setup query frame. In an implementation, after receiving the sensing measurement setup query frame, the AP may send a sensing measurement setup request frame to the U-STA, to request to set up a new sensing measurement setup with the U-STA. The U-STA may return a sensing measurement setup response frame, to indicate that the U-STA accepts or rejects the request of the AP.

In this embodiment of this application, the AP sends the sensing measurement setup termination frame, to terminate the sensing measurement setup but retain the sensing session, and the first indication information is carried in the sensing measurement setup termination frame, to notify the U-STA to come back to send the sensing measurement setup query frame to the AP before the first time, so that the AP can initiate a new sensing measurement setup with the U-STA in a condition of retaining the sensing session, to facilitate subsequent sensing measurement, and further make a sensing procedure between the AP and the U-STA more flexible.

### Embodiment 2

The embodiment 2 of this application mainly describes behavior (or a change) of T2 in a case in which a U-STA sends a sensing measurement setup termination frame to terminate all or some sensing measurement setups between an AP and the U-STA but retain a sensing session.

It may be understood that the embodiment 2 of this application mainly discusses the behavior of T2. This is because T3 is controlled by the AP, and is started only when the AP notifies the U-STA, and the U-STA does not start or reset T3. Therefore, behavior (or a change) of T3 is not discussed in this embodiment of this application. However, when a condition for starting or resetting T3 occurs, T3 changes correspondingly. For details, refer to the foregoing descriptions or the conventional technology. Details are not described herein.

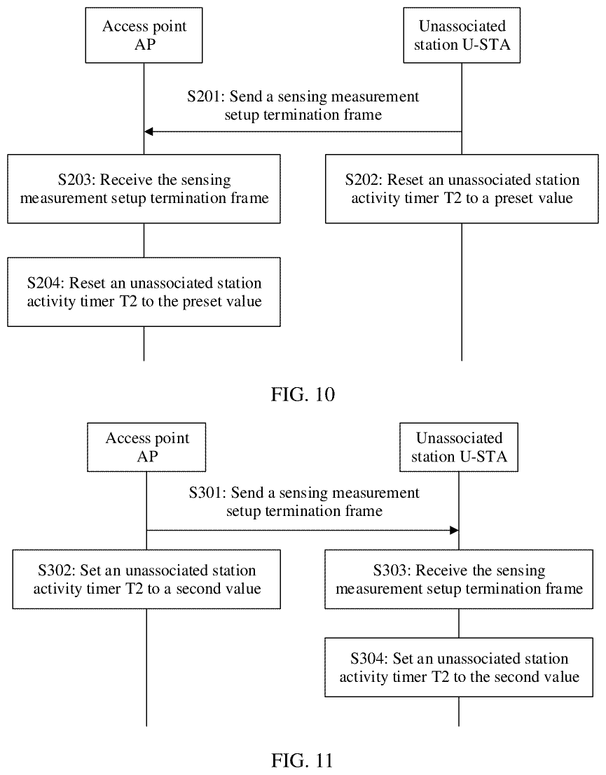

FIG. 10 is another schematic flowchart of a wireless sensing method according to an embodiment of this application. As shown in FIG. 10, the wireless sensing method includes but is not limited to the following steps.

S201: The unassociated station (U-STA) sends the sensing measurement setup termination frame to the access point (AP). The sensing measurement setup termination frame is used to terminate a sensing measurement setup but retain a sensing session.

S202: The unassociated station (U-STA) resets an unassociated station activity timer T2 to a preset value.

In an implementation, the U-STA may send the sensing measurement setup termination frame to the AP at any time before the sensing session is terminated (for example, T2 expires). The sensing measurement setup termination frame may be used to terminate all or some sensing measurement setups between the AP and the U-STA but retain the sensing session. A frame format of the sensing measurement setup termination frame may be shown in FIG. 3 and FIG. 4. As shown in FIG. 4, when the terminate U-STA sensing session field in this embodiment of this application is set to 0, it indicates that the sensing session is retained.

In a possible implementation, the sensing measurement setup termination frame is used to terminate all the sensing measurement setups between the AP and the U-STA (both the terminate all TB measurement setups field and the terminate all non-TB measurement setups field in FIG. 4 are set to 1). For example, if only one sensing measurement setup is set up between the U-STA and the AP, the sensing measurement setup termination frame may be used to terminate the MS. Alternatively, if a plurality of sensing measurement setups are set up between the U-STA and the AP, the sensing measurement setup termination frame may be used to terminate the plurality of sensing measurement setups.

If T3 is running when the U-STA sends the sensing measurement setup termination frame, it indicates that the AP needs the U-STA to send a sensing measurement setup query frame before specific time. In other words, the U-STA may subsequently set up another sensing measurement setup with the AP. It can be learned from the fourth point (that is, the sensing state machine of the U-STA) that T2 is also reset when sensing measurement is performed, and time of T2 is longer than time of T3. In this case, T3 ends before T2 ends. Therefore, after the U-STA sends the sensing measurement setup termination frame and receives an ACK frame returned by the AP, T2 may continue (continue) to count down. However, after coming back to send the sensing measurement setup query frame to the AP, the U-STA does not immediately reset T2, and resets T2 only when the U-STA and the AP successfully set up a sensing measurement setup. Therefore, to prevent the sensing session from expiring soon (that is, to prevent T2 from expiring soon) after the U-STA sends the sensing measurement setup query frame to the AP, the U-STA may reset the unassociated station activity timer T2 to the preset value after sending the sensing measurement setup termination frame. For example, the preset value is 100 s. For example, the U-STA resets T2 to the preset value after sending the sensing measurement setup termination frame and receiving the ACK frame returned by the AP.

In this embodiment of this application, if T3 is running when the U-STA sends the sensing measurement setup termination frame, T2 is reset when the acknowledgment frame for the sensing measurement setup termination frame is received. This can prolong a life cycle of the sensing session between the U-STA and the AP, and prevent a sensing session from being repeatedly set up when there is a sensing requirement, thereby reducing overheads.

If T3 is not operating when the U-STA sends the sensing measurement setup termination frame, the AP does not need to set up another sensing measurement setup with the U-STA. Therefore, after the U-STA sends the sensing measurement setup termination frame and receives the ACK frame returned by the AP, T2 may continue (continue) to count down.

In another possible implementation, the sensing measurement setup termination frame is used to terminate some sensing measurement setups between the AP and the U-STA. In other words, another sensing measurement setup exists between the AP and the U-STA. It may be understood that, in this implementation, T2 is reset due to a sensing activity (for example, performing sensing measurement) in the another sensing measurement setup. Therefore, after the U-STA sends the sensing measurement setup termination frame, T2 may continue (continue) to count down. In an implementation, to unify behavior of T2, after the U-STA sends the sensing measurement setup termination frame, T2 may alternatively be reset (reset) to the preset value. It may be understood that, in this implementation, the behavior that the U-STA sends the sensing measurement setup termination frame and retains the sensing session may also be understood as a manner in which the U-STA notifies the AP of presence of the U-STA. In other words, in this implementation, when the AP receives the sensing measurement setup termination frame, it may be determined that the U-STA is still present (or has not entered a power saving mode and has not moved out of coverage of the AP). Alternatively, in this implementation, the sensing measurement setup termination frame sent by the U-STA may be further used to notify the AP of presence of the U-STA to perform WLAN sensing.

S203: The access point (AP) receives the sensing measurement setup termination frame.

In an implementation, an execution sequence of step S202 and step S203 is not limited. For example, step S202 is performed before step S203, or step S202 is performed after step S203, or step S202 and step S203 are simultaneously performed. This is not limited in embodiments of this application.

S204: The access point (AP) resets an unassociated station activity timer T2 to the preset value.

In an implementation, the sensing measurement setup termination frame is used to terminate all the sensing measurement setups between the AP and the U-STA. If T3 is running when the AP receives the sensing measurement setup termination frame, the AP may reset the unassociated station activity timer T2 to the preset value. For example, the preset value is 100 s. For example, the AP resets T2 to the preset value after sending the ACK frame for the sensing measurement setup termination frame. If T3 is not operating when the AP receives the sensing measurement setup termination frame, after the AP sends the ACK frame for the sensing measurement setup termination frame, T2 may continue (continue) to count down.

In an implementation, the sensing measurement setup termination frame is used to terminate some sensing measurement setups between the AP and the U-STA. After the AP receives the sensing measurement setup termination frame, T2 may continue (continue) to count down. In an implementation, to unify behavior of T2, after the AP receives the sensing measurement setup termination frame, T2 may alternatively be reset (reset) to the preset value.

To more clearly understand the behavior (or the change) of T2 in this embodiment of this application, the behavior of T2 may be summarized in Table 2 below.

TABLE 2

| The U-STA sending the | T2 at U-STA and AP | T3 at U-STA and AP |
|---|---|---|
| sensing measurement | T2 of the U-STA | T3 of the U-STA |
| setup termination frame | and the AP | and the AP |
| Terminating all | continues if T3 is not | / |
| sensing measurement | operating; or is reset | |
| setups | or continues if T3 is | |
| | running. | |
| Terminating some | continues or is reset. | / |
| sensing measurement | | |
| setups | | |

In this embodiment of this application, the U-STA sends the sensing measurement setup termination frame to terminate the sensing measurement setup but retain the sensing session. In addition, if T3 is running when the U-STA sends the sensing measurement setup termination frame, T2 is reset. This can improve setting of the timer, thereby avoiding setting confusion; and can further prolong the life cycle of the sensing session between the U-STA and the AP, and prevent a sensing session from being repeatedly set up when there is the sensing requirement, thereby reducing overheads.

It may be understood that effective duration of the sensing measurement setup is also controlled by the timer, and the sensing measurement setup may be terminated by sending the sensing measurement setup termination frame in the embodiment 1 or the embodiment 2. Certainly, the sensing measurement setup may also be terminated through timer expiration. If the sensing measurement setup is terminated through timer expiration, there is no frame exchange between the AP and the U-STA. Therefore, T2 and T3 are not affected, and T2 and T3 only need to continue (or maintain) behavior thereof.

### Embodiment 3

The embodiment 3 of this application mainly describes behavior (or a change) of T2 in a case in which an AP sends a sensing measurement setup termination frame to terminate a sensing session.

It may be understood that the embodiment 3 of this application mainly discusses the behavior of T2. This is because when the AP sends the sensing measurement setup termination frame, T3 is not operating (T3 is not running), or T3 is set to 0.

It may also be understood that the embodiment 3 of this application may be separately implemented, or may be implemented in combination with the embodiment 1. When the embodiment 3 of this application is implemented in combination with the embodiment 1, the embodiment 3 of this application is performed after the embodiment 1, and the sensing measurement setup termination frame in the embodiment 1 is different from the sensing measurement setup termination frame in the embodiment 3 of this application. For example, when the embodiment 3 of this application is implemented in combination with the embodiment 1, the sensing measurement setup termination frame in the embodiment 1 may be denoted as a first sensing measurement setup termination frame, and the sensing measurement setup termination frame in the embodiment 3 of this application may be denoted as a second sensing measurement setup termination frame.

FIG. 11 is still another schematic flowchart of a wireless sensing method according to an embodiment of this application. As shown in FIG. 11, the wireless sensing method includes but is not limited to the following steps.

S301: The access point (AP) sends the sensing measurement setup termination frame to an unassociated station (U-STA). The sensing measurement setup termination frame is used to terminate the sensing session.

S302: The access point (AP) sets an unassociated station activity timer T2 to a second value.

It may be understood that only one sensing session exists between one non-AP STA (which may be the U-STA herein) and one AP. After the sensing session is terminated, no sensing measurement setup exists between the U-STA and the AP, and the U-STA and the AP may no longer store capability information of each other, for example, sensing capability information.

In an implementation, after receiving a sensing measurement setup query frame sent by the U-STA, the AP may send the sensing measurement setup termination frame to the U-STA, to terminate the sensing session. After the AP sends the sensing measurement setup termination frame, all running timers need to stop (Stop) timing, and “stop” may indicate that the timer is set to 0. In other words, the AP may set the unassociated station activity timer T2 to the second value after sending the sensing measurement setup termination frame. For example, the AP sets the unassociated station activity timer T2 to the second value when receiving an ACK frame returned by the U-STA for the sensing measurement setup query frame. For example, the second value is 0 or a value close to 0, for example, 100 MS (milliseconds), 1 s, or 2 s.

A frame format of the sensing measurement setup termination frame may be shown in FIG. 3 and FIG. 4. As shown in FIG. 4, when the terminate U-STA sensing session field in this embodiment of this application is set to 1, it indicates that the sensing session is terminated.

S303: The unassociated station (U-STA) receives the sensing measurement setup termination frame. The sensing measurement setup termination frame is used to terminate the sensing session.

In an implementation, an execution sequence of step S302 and step S303 is not limited. For example, step S302 is performed before step S303, or step S302 is performed after step S303, or step S302 and step S303 are simultaneously performed. This is not limited in embodiments of this application.

S304: The unassociated station (U-STA) sets an unassociated station activity timer T2 to the second value.

In an implementation, the U-STA may set the unassociated station activity timer T2 to the second value (for example, 0) after receiving the sensing measurement setup termination frame. For example, the U-STA sets the unassociated station activity timer T2 to the second value after sending the ACK frame for the sensing measurement setup query frame.

It may be understood that the behavior of T2 in this embodiment of this application may be summarized in Table 3 below.

TABLE 3

| The AP sending the | T2 at U-STA and AP | T3 at U-STA and AP |
|---|---|---|
| sensing measurement | T2 of the U-STA | T3 of the U-STA |
| setup termination frame | and the AP | and the AP |
| Terminating the | is set to 0 | / |
| sensing session | during stopping. | |

In this embodiment of this application, the AP sends the sensing measurement setup termination frame to terminate the sensing session, and sets T2 to zero. Therefore, setting of the timer may be specified, so that setting of the timer is consistent with a meaning of the timer, to avoid setting confusion.

### Embodiment 4

The embodiment 4 of this application mainly describes behavior (or changes) of T2 and T3 in a case in which a U-STA sends a sensing measurement setup termination frame to terminate a sensing session.

It may be understood that the embodiment 4 of this application may be separately implemented, or may be implemented in combination with the embodiment 2. When the embodiment 4 of this application is implemented in combination with the embodiment 2, the embodiment 4 of this application is performed after the embodiment 2, and the sensing measurement setup termination frame in the embodiment 2 is different from the sensing measurement setup termination frame in the embodiment 4 of this application. For example, when the embodiment 4 of this application is implemented in combination with the embodiment 2, the sensing measurement setup termination frame in the embodiment 2 may be denoted as a first sensing measurement setup termination frame, and the sensing measurement setup termination frame in the embodiment 4 of this application may be denoted as a second sensing measurement setup termination frame.

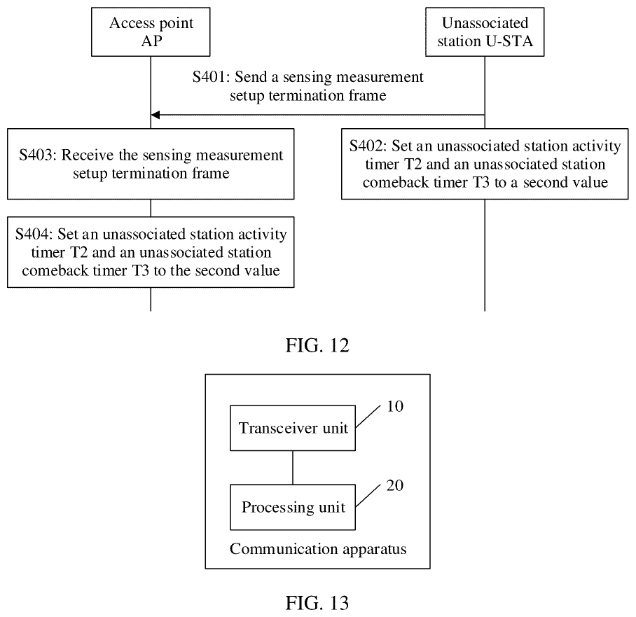

FIG. 12 is yet another schematic flowchart of a wireless sensing method according to an embodiment of this application. As shown in FIG. 12, the wireless sensing method includes but is not limited to the following steps.

S401: The unassociated station (U-STA) sends the sensing measurement setup termination frame to an access point (AP). The sensing measurement setup termination frame is used to terminate the sensing session.

S402: The unassociated station (U-STA) sets an unassociated station activity timer T2 and an unassociated station comeback timer T3 to a second value.

It may be understood that only one sensing session exists between one non-AP STA (which may be the U-STA herein) and one AP. After the sensing session is terminated, no sensing measurement setup exists between the U-STA and the AP, and the U-STA and the AP may no longer store capability information of each other, for example, sensing capability information.

It may be further understood that, when the U-STA sends the sensing measurement setup termination frame, T3 may be running or may not be operating. Therefore, the behavior of T2 and T3 may be discussed in this embodiment of this application.

In an implementation, the U-STA may send the sensing measurement setup termination frame to the AP at any time before the sensing session is terminated, to terminate the sensing session. When the U-STA sends the sensing measurement setup termination frame to terminate the sensing session, all running timers (namely, T2 and T3) stop (Stop) timing, and “stop” may indicate that the timer is set to 0. In other words, the U-STA may set both the unassociated station activity timer T2 and the unassociated station comeback timer T3 to the second value after sending the sensing measurement setup termination frame. For example, the U-STA sets both the unassociated station activity timer T2 and the unassociated station comeback timer T3 to the second value when receiving an ACK frame returned by the AP for a sensing measurement setup query frame. For example, the second value is 0 or a value close to 0, for example, 100 mms (milliseconds), 1 s, or 2 s.

A frame format of the sensing measurement setup termination frame may be shown in FIG. 3 and FIG. 4. As shown in FIG. 4, when the terminate U-STA sensing session field in this embodiment of this application is set to 1, it indicates that the sensing session is terminated.

S403: The access point (AP) receives the sensing measurement setup termination frame. The sensing measurement setup termination frame is used to terminate the sensing session.

In an implementation, an execution sequence of step S402 and step S403 is not limited. For example, step S402 is performed before step S403, or step S402 is performed after step S403, or step S402 and step S403 are simultaneously performed. This is not limited in embodiments of this application.

S404: The access point (AP) sets an unassociated station activity timer T2 and an unassociated station comeback timer T3 to the second value.

In an implementation, the AP may set both the unassociated station activity timer T2 and the unassociated station comeback timer T3 to the second value (for example, 0) after receiving the sensing measurement setup termination frame. For example, the AP sets both the unassociated station activity timer T2 and the unassociated station comeback timer T3 to the second value after sending the ACK frame for the sensing measurement setup query frame.

It may be understood that the behavior of T2 and T3 in this embodiment of this application may be summarized in Table 4 below.

TABLE 4

| The U-STA sending the | T2 at U-STA and AP | T3 at U-STA and AP |
|---|---|---|
| sensing measurement | T2 of the U-STA | T3 of the U-STA |
| setup termination frame | and the AP | and the AP |
| Terminating the | is set to 0 | is set to 0 |
| sensing session | during stopping. | during stopping. |

In this embodiment of this application, the U-STA sends the sensing measurement setup termination frame to terminate the sensing session, and sets both T2 and T3 to zero. Therefore, setting of the timer may be specified, so that setting of the timer is consistent with a meaning of the timer, to avoid setting confusion.

The foregoing describes in detail the method in this application. To better implement the foregoing solutions in embodiments of this application, embodiments of this application further provide a corresponding apparatus or device.

In this application, an access point (AP) and an unassociated station (U-STA) are divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, in this application, module division is an example, and is merely logical function division. During actual implementation, another division manner may be used. The following describes in detail communication apparatuses in embodiments of this application with reference to FIG. 13 to FIG. 15.

FIG. 13 is a diagram of a structure of a communication apparatus according to an embodiment of this application. As shown in FIG. 13, the communication apparatus includes a transceiver unit 10 and a processing unit 20.

In some embodiments of this application, the communication apparatus may be the access point (AP) shown above or a chip therein, for example, a Wi-Fi chip. In other words, the communication apparatus shown in FIG. 13 may be configured to perform a step, a function, or the like performed by the access point (AP) in the method embodiments.

In a design, the transceiver unit 10 is configured to send a first sensing measurement setup termination frame to a U-STA, where the first sensing measurement setup termination frame is used to terminate a sensing measurement setup but retain a sensing session, the first sensing measurement setup termination frame includes first indication information, and the first indication information is used to notify the U-STA to send a sensing measurement setup query frame before first time. The transceiver unit 10 is further configured to receive the sensing measurement setup query frame sent by the U-STA.

For example, the first indication information includes latest time at which the U-STA sends the sensing measurement setup query frame. The processing unit 20 is configured to start an unassociated station comeback timer T3. A value of the unassociated station comeback timer T3 is determined based on the latest time, and the first time is the latest time.

For example, the processing unit 20 is specifically configured to start the unassociated station comeback timer T3 when receiving an acknowledgment frame sent by the U-STA for the first sensing measurement setup termination frame.

For example, the first sensing measurement setup termination frame further includes second indication information, and the second indication information indicates existence of the first indication information.

For example, the first indication information is a comeback indication, and the comeback indication indicates that the unassociated station needs to send the sensing measurement setup query frame. The first time is time in which an unassociated station activity timer T2 counts down to zero.

For example, the processing unit 20 is further configured to reset the unassociated station activity timer T2 to a preset value.

For example, the processing unit 20 is specifically configured to reset the unassociated station activity timer T2 to the preset value when receiving the acknowledgment frame sent by the U-STA for the first sensing measurement setup termination frame.

For example, that the first sensing measurement setup termination frame is used to terminate the sensing measurement setup includes: The first sensing measurement setup termination frame is used to terminate all sensing measurement setups between the AP and the U-STA, or the first sensing measurement setup termination frame is used to terminate all trigger-based TB sensing measurement setups between the AP and the U-STA.

For example, the transceiver unit 10 is further configured to send a second sensing measurement setup termination frame, where the second sensing measurement setup termination frame is used to terminate the sensing session. The processing unit 20 is further configured to set the unassociated station activity timer T2 to zero.

It may be understood that specific descriptions of the transceiver unit and the processing unit that are described in embodiments of this application are merely examples. For specific functions, performed steps, or the like of the transceiver unit and the processing unit, refer to the method embodiment 1. Details are not described herein. For example, the processing unit 20 may be configured to generate the sensing measurement setup termination frame sent in step S101 shown in FIG. 7. The transceiver unit 10 may be configured to perform step S101 and step S104 shown in FIG. 7.

In another design, the transceiver unit 10 is configured to receive a first sensing measurement setup termination frame, where the first sensing measurement setup termination frame is used to terminate a sensing measurement setup but retain a sensing session. The processing unit 20 is configured to reset an unassociated station activity timer T2 to a preset value.

For example, that the first sensing measurement setup termination frame is used to terminate the sensing measurement setup includes: The first sensing measurement setup termination frame is used to terminate all sensing measurement setups between a U-STA and the AP.

For example, the processing unit 20 is further configured to determine that an unassociated station comeback timer T3 is running.

For example, the transceiver unit 10 is further configured to receive a second sensing measurement setup termination frame, where the second sensing measurement setup termination frame is used to terminate the sensing session. The processing unit 20 is further configured to set both the unassociated station activity timer T2 and the unassociated station comeback timer T3 to zero.

It may be understood that specific descriptions of the transceiver unit and the processing unit that are described in embodiments of this application are merely examples. For specific functions, performed steps, or the like of the transceiver unit and the processing unit, refer to the method embodiment 2. Details are not described herein. For example, the transceiver unit 10 may be configured to perform step S203 shown in FIG. 10, and the processing unit 20 may be configured to perform step S204 shown in FIG. 10.

In still another design, the transceiver unit 10 is configured to send a sensing measurement setup termination frame to a U-STA, where the sensing measurement setup termination frame is used to terminate a sensing session. The processing unit 20 is configured to set an unassociated station activity timer T2 to a second value.

For example, the second value is zero.

For example, the processing unit 20 is specifically configured to set the unassociated station activity timer T2 to the second value when receiving an acknowledgment frame from the U-STA. The acknowledgment frame is an acknowledgment frame for the sensing measurement setup termination frame.

It may be understood that specific descriptions of the transceiver unit and the processing unit that are described in embodiments of this application are merely examples. For specific functions, performed steps, or the like of the transceiver unit and the processing unit, refer to the method embodiment 3. Details are not described herein. For example, the transceiver unit 10 may be configured to perform step S301 shown in FIG. 11, and the processing unit 20 may be configured to perform step S302 shown in FIG. 11.

In yet another design, the transceiver unit 10 is configured to receive a sensing measurement setup termination frame. The sensing measurement setup termination frame is used to terminate a sensing session. The processing unit 20 is configured to set an unassociated station activity timer T2 and an unassociated station comeback timer T3 to a second value.

For example, the second value is zero.

For example, the processing unit 20 is specifically configured to set both the unassociated station activity timer T2 and the unassociated station comeback timer T3 to the second value after sending an acknowledgment frame for the sensing measurement setup termination frame.

It may be understood that specific descriptions of the transceiver unit and the processing unit that are described in embodiments of this application are merely examples. For specific functions, performed steps, or the like of the transceiver unit and the processing unit, refer to the method embodiment 4. Details are not described herein. For example, the transceiver unit 10 may be configured to perform step S403 shown in FIG. 12, and the processing unit 20 may be configured to perform step S404 shown in FIG. 12.

FIG. 13 is reused. In some other embodiments of this application, the communication apparatus may be the unassociated station (U-STA) shown above or a chip therein, for example, a Wi-Fi chip. In other words, the communication apparatus shown in FIG. 13 may be configured to perform a step, a function, or the like performed by the unassociated station (U-STA) in the method embodiments.

In a design, the transceiver unit 10 is configured to receive a first sensing measurement setup termination frame sent by an AP, where the first sensing measurement setup termination frame is used to terminate a sensing measurement setup but retain a sensing session, the first sensing measurement setup termination frame includes first indication information, and the first indication information is used to notify the U-STA to send a sensing measurement setup query frame before first time. The transceiver unit 10 is further configured to send the sensing measurement setup query frame to the AP based on the first indication information.

For example, the first indication information includes latest time at which the U-STA sends the sensing measurement setup query frame. The processing unit 20 is configured to start an unassociated station comeback timer T3, where a value of the unassociated station comeback timer T3 is determined based on the latest time, and the first time is the latest time.

For example, the processing unit 20 is specifically configured to start the unassociated station comeback timer T3 after sending an acknowledgment frame for the first sensing measurement setup termination frame.

For example, the first sensing measurement setup termination frame further includes second indication information, and the second indication information indicates existence of the first indication information.

For example, the first indication information is a comeback indication, and the comeback indication indicates that the U-STA needs to send the sensing measurement setup query frame. The processing unit 20 is further configured to determine that the first time is time in which an unassociated station activity timer T2 counts down to zero.

For example, the processing unit 20 is further configured to reset the unassociated station activity timer T2 to a preset value.

For example, the processing unit 20 is specifically configured to reset the unassociated station activity timer T2 to the preset value after sending the acknowledgment frame for the first sensing measurement setup termination frame.

For example, that the first sensing measurement setup termination frame is used to terminate the sensing measurement setup includes: The first sensing measurement setup termination frame is used to terminate all sensing measurement setups between the U-STA and the AP, or the first sensing measurement setup termination frame is used to terminate all trigger-based TB sensing measurement setups between the U-STA and the AP.

For example, the transceiver unit 10 is further configured to receive a second sensing measurement setup termination frame sent by the AP, where the second sensing measurement setup termination frame is used to terminate the sensing session. The processing unit 20 is further configured to set the unassociated station activity timer T2 to zero.

It may be understood that specific descriptions of the transceiver unit and the processing unit that are described in embodiments of this application are merely examples. For specific functions, performed steps, or the like of the transceiver unit and the processing unit, refer to the method embodiment 1. Details are not described herein. For example, the processing unit 20 may be configured to generate the sensing measurement setup query frame sent in step S103 shown in FIG. 7. The transceiver unit 10 may be configured to perform step S102 and step S103 shown in FIG. 7.

In another design, the transceiver unit 10 is configured to send a first sensing measurement setup termination frame, where the first sensing measurement setup termination frame is used to terminate a sensing measurement setup but retain a sensing session. The processing unit 20 is configured to reset an unassociated station activity timer T2 to a preset value.

For example, that the first sensing measurement setup termination frame is used to terminate the sensing measurement setup includes: The first sensing measurement setup termination frame is used to terminate all sensing measurement setups between the U-STA and an AP.

For example, the processing unit 20 is further configured to determine that an unassociated station comeback timer T3 is running.

For example, the transceiver unit 10 is further configured to send a second sensing measurement setup termination frame, where the second sensing measurement setup termination frame is used to terminate the sensing session. The processing unit 20 is further configured to set both the unassociated station activity timer T2 and the unassociated station comeback timer T3 to zero.

It may be understood that specific descriptions of the transceiver unit and the processing unit that are described in embodiments of this application are merely examples. For specific functions, performed steps, or the like of the transceiver unit and the processing unit, refer to the method embodiment 2. Details are not described herein. For example, the transceiver unit 10 may be configured to perform step S201 shown in FIG. 10, and the processing unit 20 may be configured to perform step S202 shown in FIG. 10.

In still another design, the transceiver unit 10 is configured to receive a sensing measurement setup termination frame, where the sensing measurement setup termination frame is used to terminate the sensing session. The processing unit 20 is configured to set an unassociated station activity timer T2 to a second value.

For example, the second value is zero.

For example, the processing unit 20 is specifically configured to set the unassociated station activity timer T2 to the second value after sending the acknowledgment frame for the sensing measurement setup termination frame.

It may be understood that specific descriptions of the transceiver unit and the processing unit that are described in embodiments of this application are merely examples. For specific functions, performed steps, or the like of the transceiver unit and the processing unit, refer to the method embodiment 3. Details are not described herein. For example, the transceiver unit 10 may be configured to perform step S303 shown in FIG. 11, and the processing unit 20 may be configured to perform step S304 shown in FIG. 11.

In yet another design, the transceiver unit 10 is configured to send a sensing measurement setup termination frame. The sensing measurement setup termination frame is used to terminate a sensing session. The processing unit 20 is configured to set an unassociated station activity timer T2 and an unassociated station comeback timer T3 to a second value.

For example, the second value is zero.

For example, the processing unit 20 is specifically configured to set both the unassociated station activity timer T2 and the unassociated station comeback timer T3 to the second value when receiving an acknowledgment frame from an AP. The acknowledgment frame is an acknowledgment frame for the sensing measurement setup termination frame.

It may be understood that specific descriptions of the transceiver unit and the processing unit that are described in embodiments of this application are merely examples. For specific functions, performed steps, or the like of the transceiver unit and the processing unit, refer to the method embodiment 4. Details are not described herein. For example, the transceiver unit 10 may be configured to perform step S401 shown in FIG. 12, and the processing unit 20 may be configured to perform step S402 shown in FIG. 12.

The foregoing describes the communication apparatus in embodiments of this application. The following describes a possible product form of the communication apparatus. It should be understood that any product in any form that has a function of the communication apparatus in FIG. 13 falls within the protection scope of embodiments of this application. It should be further understood that the following descriptions are merely examples, and do not limit the product form of the communication apparatus in embodiments of this application.

In a possible implementation, in the communication apparatus shown in FIG. 13, the processing unit 20 may be one or more processors. The transceiver unit 10 may be a transceiver, or the transceiver unit 10 may be a sending unit and a receiving unit. The sending unit may be a transmitter, and the receiving unit may be a receiver. The sending unit and the receiving unit are integrated into one component, for example, a transceiver. In this embodiment of this application, the processor and the transceiver may be coupled, or the like. A manner of connection between the processor and the transceiver is not limited in embodiments of this application. In a process of performing the foregoing method, a process of sending information (for example, sending various frames) in the foregoing method may be understood as a process of outputting the information by the processor. When outputting the information, the processor outputs the information to the transceiver, so that the transceiver transmits the information. After the information is output by the processor, other processing may further need to be performed on the information before processed information arrives at the transceiver. Similarly, a process of receiving information (for example, receiving various frames) in the foregoing method may be understood as a process of receiving the input information by the processor. When the processor receives the input information, the transceiver receives the information, and inputs the information into the processor. Further, after the transceiver receives the information, other processing may further need to be performed on the information before processed information is input into the processor.

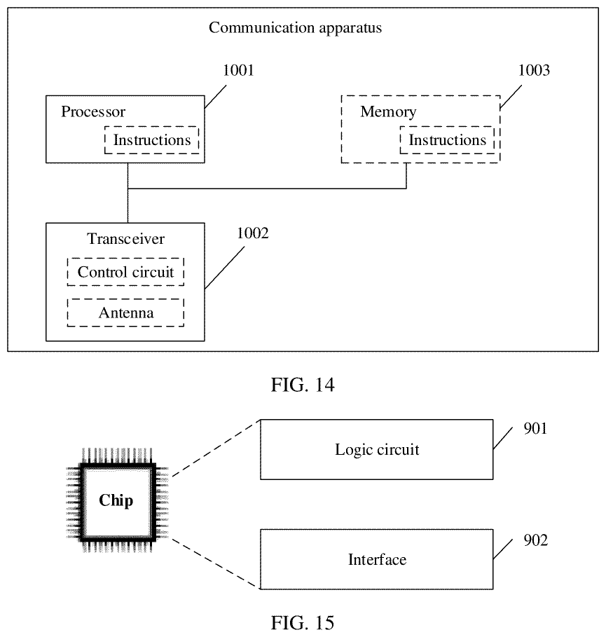

FIG. 14 is a diagram of another structure of a communication apparatus according to an embodiment of this application. The communication apparatus may be an AP, a U-STA, or a chip therein. FIG. 14 shows only main components of the communication apparatus. In addition to a processor 1001 and a transceiver 1002, the communication apparatus may further include a memory 1003. In an implementation, the communication apparatus further includes an input/output apparatus (not shown in the figure).

The processor 1001 is mainly configured to process a communication protocol and communication data, control the entire communication apparatus, execute a software program, and process data of the software program. The memory 1003 is mainly configured to store the software program and data. The transceiver 1002 may include a control circuit and an antenna. The control circuit is mainly configured to perform conversion between a baseband signal and a radio frequency signal, and process the radio frequency signal. The antenna is mainly configured to receive or send a radio frequency signal in a form of an electromagnetic wave. The input/output apparatus, such as a touchscreen, a display, or a keyboard, is mainly configured to: receive data input by a user and output data to the user.

After the communication apparatus is powered on, the processor 1001 may read the software program in the memory 1003, interpret and execute instructions of the software program, and process data of the software program. When data needs to be sent wirelessly, the processor 1001 performs baseband processing on the to-be-sent data, and then outputs a baseband signal to the radio frequency circuit. The radio frequency circuit performs radio frequency processing on the baseband signal, and then sends a radio frequency signal in a form of an electromagnetic wave through the antenna. When data is sent to the communication apparatus, the radio frequency circuit receives the radio frequency signal through the antenna, converts the radio frequency signal into a baseband signal, and outputs the baseband signal to the processor 1001. The processor 1001 converts the baseband signal into data and processes the data.

In another implementation, the radio frequency circuit and the antenna may be disposed independently of the processor that performs baseband processing. For example, in a distributed scenario, the radio frequency circuit and the antenna may be remotely disposed independently of the communication apparatus.

The transceiver 1002 may include a receiver and a transmitter. The receiver is configured to perform a receiving function (or operation), and the transmitter is configured to perform a transmitting function (or operation). The transceiver is configured to communicate with another device/apparatus through a transmission medium.

The processor 1001, the transceiver 1002, and the memory 1003 may be connected through a communication bus.

For example, when the communication apparatus is configured to perform a step, a method, or a function performed by the AP in the method embodiment 1, the transceiver 1002 is configured to send a sensing measurement setup termination frame to the U-STA, where the sensing measurement setup termination frame is used to terminate a sensing measurement setup but retain a sensing session, the sensing measurement setup termination frame includes first indication information, and the first indication information is used to notify the U-STA to send a sensing measurement setup query frame before first time. The transceiver 1002 is further configured to receive the sensing measurement setup query frame sent by the U-STA. In an implementation, the processor 1001 is configured to generate the sensing measurement setup termination frame.

For example, when the communication apparatus is configured to perform a step, a method, or a function performed by the U-STA in the method embodiment 1, the transceiver 1002 is configured to receive the sensing measurement setup termination frame sent by the AP, where the sensing measurement setup termination frame is used to terminate the sensing measurement setup but retain the sensing session, the sensing measurement setup termination frame includes the first indication information, and the first indication information is used to notify the U-STA to send the sensing measurement setup query frame before the first time. The transceiver 1002 is further configured to send the sensing measurement setup query frame to the AP based on the first indication information. In an implementation, the processor 1001 is configured to generate the sensing measurement setup query frame.

In this embodiment of this application, for descriptions of the sensing measurement setup termination frame, the sensing measurement setup query frame, the first indication information, the AP, the U-STA, and the like, refer to the descriptions in the method embodiment 1. Details are not described herein again. It may be understood that for specific descriptions of the processor and the transceiver, refer to the descriptions of the processing unit and the transceiver unit shown in FIG. 13. Details are not described herein again.

For example, when the communication apparatus is configured to perform a step, a method, or a function performed by the AP in the method embodiment 2, the transceiver 1002 is configured to receive a sensing measurement setup termination frame, where the sensing measurement setup termination frame is used to terminate a sensing measurement setup but retain a sensing session. The processor 1001 is configured to reset an unassociated station activity timer T2 to a preset value.

For example, when the communication apparatus is configured to perform a step, a method, or a function performed by the U-STA in the method embodiment 2, the transceiver 1002 is configured to send a sensing measurement setup termination frame, where the sensing measurement setup termination frame is used to terminate a sensing measurement setup but retain a sensing session. The processor 1001 is configured to reset an unassociated station activity timer T2 to a preset value.

In this embodiment of this application, for descriptions of the sensing measurement setup termination frame, the unassociated station activity timer T2, the AP, the U-STA, and the like, refer to the descriptions in the method embodiment 2. Details are not described herein again. It may be understood that for specific descriptions of the processor and the transceiver, refer to the descriptions of the processing unit and the transceiver unit shown in FIG. 13. Details are not described herein again.

For example, when the communication apparatus is configured to perform a step, a method, or a function performed by the AP in the method embodiment 3, the transceiver 1002 is configured to send a sensing measurement setup termination frame to the U-STA, where the sensing measurement setup termination frame is used to terminate a sensing session. The processor 1001 is configured to set an unassociated station activity timer T2 to a second value.

For example, when the communication apparatus is configured to perform a step, a method, or a function performed by the U-STA in the method embodiment 3, the transceiver 1002 is configured to receive a sensing measurement setup termination frame, where the sensing measurement setup termination frame is used to terminate a sensing session. The processor 1001 is configured to set an unassociated station activity timer T2 to a second value.

In this embodiment of this application, for descriptions of the sensing measurement setup termination frame, the unassociated station activity timer T2, the AP, the U-STA, and the like, refer to the descriptions in the method embodiment 3. Details are not described herein again. It may be understood that for specific descriptions of the processor and the transceiver, refer to the descriptions of the processing unit and the transceiver unit shown in FIG. 13. Details are not described herein again.

For example, when the communication apparatus is configured to perform a step, a method, or a function performed by the AP in the method embodiment 4, the transceiver 1002 is configured to receive a sensing measurement setup termination frame. The sensing measurement setup termination frame is used to terminate a sensing session. The processor 1001 is configured to set an unassociated station activity timer T2 and an unassociated station comeback timer T3 to a second value.

For example, when the communication apparatus is configured to perform a step, a method, or a function performed by the U-STA in the method embodiment 4, the transceiver 1002 is configured to send a sensing measurement setup termination frame. The sensing measurement setup termination frame is used to terminate a sensing session. The processor 1001 is configured to set an unassociated station activity timer T2 and an unassociated station comeback timer T3 to a second value.

In this embodiment of this application, for descriptions of the sensing measurement setup termination frame, the unassociated station activity timer T2, the unassociated station comeback timer T3, the AP, the U-STA, and the like, refer to the descriptions in the method embodiment 4. Details are not described herein again. It may be understood that for specific descriptions of the processor and the transceiver, refer to the descriptions of the processing unit and the transceiver unit shown in FIG. 13. Details are not described herein again.

In an implementation, the processor 1001 may store instructions. The instructions may be a computer program. The computer program is run on the processor 1001, so that the communication apparatus performs the method described in the method embodiments. The computer program may be fixed in the processor 1001. In this case, the processor 1001 may be implemented by hardware.

In an implementation, the communication apparatus may include a circuit. The circuit may implement the sending, receiving, or communication function in the method embodiments. The processor and the transceiver described in this application may be implemented on an integrated circuit (integrated circuit, IC), an analog IC, a radio frequency integrated circuit (radio frequency integrated circuit, RFIC), a mixed-signal IC, an application-specific integrated circuit (application-specific integrated circuit, ASIC), a printed circuit board (printed circuit board, PCB), an electronic device, or the like. The processor and the transceiver may alternatively be manufactured by using various IC technologies, for example, a complementary metal oxide semiconductor (complementary metal oxide semiconductor, CMOS), an N-type metal oxide semiconductor (N-type metal oxide semiconductor, NMOS), a P-type metal oxide semiconductor (positive channel metal oxide semiconductor, PMOS), a bipolar junction transistor (bipolar junction transistor, BJT), a bipolar CMOS (Bascoms), silicon germanium (Siege), and gallium arsenide (GaAs).

It may be understood that the communication apparatus described in embodiments of this application may further have more components than those shown in FIG. 14, and the like. This is not limited in embodiments of this application. The foregoing methods performed by the processor and the transceiver are merely examples. For specific steps performed by the processor and the transceiver, refer to the descriptions in the method embodiments.

In another possible implementation, in the communication apparatus shown in FIG. 13, the processing unit 20 may be one or more logic circuits, and the transceiver unit 10 may be an input/output interface that is also referred to as a communication interface, an interface circuit, an interface, or the like. Alternatively, the transceiver unit 10 may be a sending unit and a receiving unit. The sending unit may be an output interface, and the receiving unit may be an input interface. The sending unit and the receiving unit are integrated into one unit, for example, an input/output interface. FIG. 15 is a diagram of still another structure of a communication apparatus according to an embodiment of this application. As shown in FIG. 15, the communication apparatus shown in FIG. 15 includes a logic circuit 901 and an interface 902. In other words, the processing unit 20 may be implemented via the logic circuit 901, and the transceiver unit 10 may be implemented via the interface 902. The logic circuit 901 may be a chip, a processing circuit, an integrated circuit, a system on chip (system on chip, SoC), or the like. The interface 902 may be a communication interface, an input/output interface, a pin, or the like. For example, FIG. 15 shows an example in which the communication apparatus is a chip. The chip includes the logic circuit 901 and the interface 902.

In this embodiment of this application, the logic circuit and the interface may be further coupled to each other. A specific manner of connection between the logic circuit and the interface is not limited in embodiments of this application.

For example, when the communication apparatus is configured to perform a step, a method, or a function performed by an AP in the method embodiment 1, the interface 902 is configured to send a sensing measurement setup termination frame to a U-STA, where the sensing measurement setup termination frame is used to terminate a sensing measurement setup but retain a sensing session, the sensing measurement setup termination frame includes first indication information, and the first indication information is used to notify the U-STA to send a sensing measurement setup query frame before first time. The interface 902 is further configured to receive the sensing measurement setup query frame sent by the U-STA. In an implementation, the logic circuit 901 is configured to generate the sensing measurement setup termination frame.

For example, when the communication apparatus is configured to perform a step, a method, or a function performed by a U-STA in the method embodiment 1, the interface 902 is configured to receive a sensing measurement setup termination frame sent by an AP, where the sensing measurement setup termination frame is used to terminate a sensing measurement setup but retain a sensing session, the sensing measurement setup termination frame includes first indication information, and the first indication information is used to notify the U-STA to send a sensing measurement setup query frame before first time. The interface 902 is further configured to send the sensing measurement setup query frame to the AP based on the first indication information. In an implementation, the logic circuit 901 is configured to generate the sensing measurement setup query frame.

In this embodiment of this application, for descriptions of the sensing measurement setup termination frame, the sensing measurement setup query frame, the first indication information, the AP, the U-STA, and the like, refer to the descriptions in the method embodiment 1. Details are not described herein again. It may be understood that for specific descriptions of the logic circuit 901 and the interface 902, refer to the descriptions of the processing unit and the transceiver unit shown in FIG. 13. Details are not described herein again.

For example, when the communication apparatus is configured to perform a step, a method, or a function performed by an AP in the method embodiment 2, the interface 902 is configured to receive a sensing measurement setup termination frame, where the sensing measurement setup termination frame is used to terminate a sensing measurement setup but retain a sensing session. The logic circuit 901 is configured to reset an unassociated station activity timer T2 to a preset value.

For example, when the communication apparatus is configured to perform a step, a method, or a function performed by a U-STA in the method embodiment 2, the interface 902 is configured to send a sensing measurement setup termination frame, where the sensing measurement setup termination frame is used to terminate a sensing measurement setup but retain a sensing session. The logic circuit 901 is configured to reset an unassociated station activity timer T2 to a preset value.

In this embodiment of this application, for descriptions of the sensing measurement setup termination frame, the unassociated station activity timer T2, the AP, the U-STA, and the like, refer to the descriptions in the method embodiment 2. Details are not described herein again. It may be understood that for specific descriptions of the logic circuit 901 and the interface 902, refer to the descriptions of the processing unit and the transceiver unit shown in FIG. 13. Details are not described herein again.

For example, when the communication apparatus is configured to perform a step, a method, or a function performed by an AP in the method embodiment 3, the interface 902 is configured to send a sensing measurement setup termination frame to a U-STA, where the sensing measurement setup termination frame is used to terminate a sensing session. The logic circuit 901 is configured to set an unassociated station activity timer T2 to a second value.

For example, when the communication apparatus is configured to perform a step, a method, or a function performed by a U-STA in the method embodiment 3, the interface 902 is configured to receive a sensing measurement setup termination frame, where the sensing measurement setup termination frame is used to terminate a sensing session. The logic circuit 901 is configured to set an unassociated station activity timer T2 to a second value.

In this embodiment of this application, for descriptions of the sensing measurement setup termination frame, the unassociated station activity timer T2, the AP, the U-STA, and the like, refer to the descriptions in the method embodiment 3. Details are not described herein again. It may be understood that for specific descriptions of the logic circuit 901 and the interface 902, refer to the descriptions of the processing unit and the transceiver unit shown in FIG. 13. Details are not described herein again.

For example, when the communication apparatus is configured to perform a step, a method, or a function performed by an AP in the method embodiment 4, the interface 902 is configured to receive a sensing measurement setup termination frame. The sensing measurement setup termination frame is used to terminate a sensing session. The logic circuit 901 is configured to set an unassociated station activity timer T2 and an unassociated station comeback timer T3 to a second value.

For example, when the communication apparatus is configured to perform a step, a method, or a function performed by a U-STA in the method embodiment 4, the interface 902 is configured to send a sensing measurement setup termination frame. The sensing measurement setup termination frame is used to terminate a sensing session. The logic circuit 901 is configured to set an unassociated station activity timer T2 and an unassociated station comeback timer T3 to a second value.

In this embodiment of this application, for descriptions of the sensing measurement setup termination frame, the unassociated station activity timer T2, the unassociated station comeback timer T3, the AP, the U-STA, and the like, refer to the descriptions in the method embodiment 4. Details are not described herein again. It may be understood that for specific descriptions of the logic circuit 901 and the interface 902, refer to the descriptions of the processing unit and the transceiver unit shown in FIG. 13. Details are not described herein again.

It may be understood that the communication apparatus shown in this embodiment of this application may implement the method provided in embodiments of this application in a form of hardware, or may implement the method provided in embodiments of this application in a form of software. This is not limited in embodiments of this application.

For specific implementations of the embodiment shown in FIG. 15, refer to the foregoing embodiments. Details are not described herein again.

An embodiment of this application further provides a wireless communication system. The wireless communication system includes an AP and a U-STA. The AP and the U-STA may be configured to perform the method in any one of the foregoing method embodiments.

In addition, this application further provides a computer program. The computer program is used to implement an operation and/or processing that are/is performed by an AP in the method provided in this application.

This application further provides a computer program. The computer program is used to implement an operation and/or processing that are/is performed by a U-STA in the method provided in this application.

This application further provides a computer-readable storage medium. The computer-readable storage medium stores computer code. When the computer code is run on a computer, the computer is enabled to perform an operation and/or processing that are/is performed by an AP in the method provided in this application.

This application further provides a computer-readable storage medium. The computer-readable storage medium stores computer code. When the computer code is run on a computer, the computer is enabled to perform an operation and/or processing that are/is performed by a U-STA in the method provided in this application.

This application further provides a computer program product. The computer program product includes computer code or a computer program. When the computer code or the computer program is run on a computer, an operation and/or processing that are/is performed by an AP in the method provided in this application are/is performed.

This application further provides a computer program product. The computer program product includes computer code or a computer program. When the computer code or the computer program is run on a computer, an operation and/or processing that are/is performed by a U-STA in the method provided in this application are/is performed.

In the several embodiments provided in this application, it should be understood that the disclosed system, apparatus, and method may be implemented in another manner. For example, the described apparatus embodiments are merely examples. For example, division into the units is merely logical function division. During actual implementation, there may be another division manner. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located at one location, or may be distributed on a plurality of network units. Some or all of the units may be selected based on an actual requirement to achieve the technical effect of the solutions provided in embodiments of this application.

In addition, functional units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in a form of a software product. The computer software product is stored in a readable storage medium, and includes several instructions for instructing a computer device (which may be a personal computer, a server, a network device, or the like) to perform all or some of the steps of the methods described in embodiments of this application. The readable storage medium includes any medium that can store program code, such as a USB flash drive, a removable hard disk drive, a read-only memory (read-only memory, ROM), a random access memory (random access memory, RAM), a magnetic disk, or an optical disc.

1. A communication apparatus, comprising a processor and a memory, wherein
the memory is configured to store instructions; and
the processor is configured to execute the instructions, to cause the communication apparatus to:
send a first sensing measurement setup termination frame to an unassociated station, wherein the first sensing measurement setup termination frame is used to terminate a sensing measurement setup but retain a sensing session, the first sensing measurement setup termination frame comprises first indication information, and the first indication information is used to notify the unassociated station to send a sensing measurement setup query frame before first time; and
receive the sensing measurement setup query frame sent by the unassociated station.

2. The communication apparatus according to claim 1, wherein the first indication information comprises latest time at which the unassociated station sends the sensing measurement setup query frame; and
the processor is further configured to execute the instructions, to cause the communication apparatus to:
start an unassociated station comeback timer after sending the first sensing measurement setup termination frame to the unassociated station, wherein a value of the unassociated station comeback timer is determined based on the latest time, and the first time is the latest time.

3. The communication apparatus according to claim 2, wherein the processor is further configured to execute the instructions, to cause the communication apparatus to:
start the unassociated station comeback timer when receiving an acknowledgment frame from the unassociated station, wherein the acknowledgment frame is an acknowledgment frame for the first sensing measurement setup termination frame.

4. The communication apparatus according to claim 2, wherein the first sensing measurement setup termination frame further comprises second indication information, and the second indication information indicates existence of the first indication information.

5. The communication apparatus according to claim 1, wherein the first indication information is a comeback indication, the comeback indication indicates that the unassociated station needs to send the sensing measurement setup query frame, and the first time is time in which an unassociated station activity timer counts down to zero.

6. The communication apparatus according to claim 1, wherein the processor is further configured to execute the instructions, to cause the communication apparatus to:
reset the unassociated station activity timer to a preset value.

7. The communication apparatus according to claim 6, wherein the processor is configured to execute the instructions, to cause the communication apparatus to:
reset the unassociated station activity timer to the preset value when receiving the acknowledgment frame from the unassociated station, wherein the acknowledgment frame is the acknowledgment frame for the first sensing measurement setup termination frame.

8. The communication apparatus according to claim 1, wherein
the first sensing measurement setup termination frame is used to terminate all sensing measurement setups between the access point and the unassociated station, or the first sensing measurement setup termination frame is used to terminate all trigger-based TB sensing measurement setups between the access point and the unassociated station.

9. The communication apparatus according to claim 1, wherein the processor is configured to execute the instructions, to cause the communication apparatus to:
send a second sensing measurement setup termination frame, wherein the second sensing measurement setup termination frame is used to terminate the sensing session; and
set the unassociated station activity timer to zero.

10. A communication apparatus, comprising a processor and a memory, wherein
the memory is configured to store instructions; and
the processor is configured to execute the instructions, to cause the communication apparatus to:
receive, a first sensing measurement setup termination frame sent by an access point, wherein the first sensing measurement setup termination frame is used to terminate a sensing measurement setup but retain a sensing session, the first sensing measurement setup termination frame comprises first indication information, and the first indication information is used to notify an unassociated station to send a sensing measurement setup query frame before first time; and
send the sensing measurement setup query frame to the access point based on the first indication information.

11. The communication apparatus according to claim 10, wherein the first indication information comprises latest time at which the unassociated station sends the sensing measurement setup query frame; and the processor is further configured to execute the instructions, to cause the communication apparatus to:
start an unassociated station comeback timer after receiving the first sensing measurement setup termination frame, wherein a value of the unassociated station comeback timer is determined based on the latest time, and the first time is the latest time.

12. The communication apparatus according to claim 11, wherein the processor is configured to execute the instructions, to cause the communication apparatus to:
start the unassociated station comeback timer after sending an acknowledgment frame for the first sensing measurement setup termination frame.

13. The communication apparatus according to claim 11, wherein the first sensing measurement setup termination frame further comprises second indication information, and the second indication information indicates existence of the first indication information.

14. The communication apparatus according to claim 10, wherein the first indication information is a comeback indication, and the comeback indication indicates that the unassociated station needs to send the sensing measurement setup query frame; and
the processor is further configured to execute the instructions, to cause the communication apparatus to: determine that the first time is time in which the unassociated station activity timer counts down to zero.

15. The communication apparatus according to claim 10, wherein the processor is further configured to execute the instructions, to cause the communication apparatus to:
reset the unassociated station activity timer to a preset value.

16. The communication apparatus according to claim 15, wherein the processor is configured to execute the instructions, to cause the communication apparatus to:
reset the unassociated station activity timer to the preset value after sending the acknowledgment frame for the sensing measurement setup termination frame.

17. The communication apparatus according to claim 10, wherein the first sensing measurement setup termination frame is used to terminate all sensing measurement setups between the unassociated station and the access point, or the first sensing measurement setup termination frame is used to terminate all trigger-based TB sensing measurement setups between the unassociated station and the access point.

18. The communication apparatus according to claim 10, wherein the processor is further configured to execute the instructions, to cause the communication apparatus to:
receive a second sensing measurement setup termination frame sent by the access point, wherein the second sensing measurement setup termination frame is used to terminate the sensing session; and
set the unassociated station activity timer to zero.

19. A communication apparatus, comprising a processor and a memory, wherein
the memory is configured to store instructions; and
the processor is configured to execute the instructions, to cause the communication apparatus to:
send or receive a first sensing measurement setup termination frame, wherein the first sensing measurement setup termination frame is used to terminate a sensing measurement setup but retain a sensing session; and
reset an unassociated station activity timer to a preset value.

20. The communication apparatus according to claim 19, wherein the processor is further configured to execute the instructions, to cause the communication apparatus to:
determine, that an unassociated station comeback timer is running before resetting the unassociated station activity timer T2 to the preset value.
